(19) United States
(12) Patent Application Publication
(10) Pub. No.: US 2026/0291024 A1
(43) Pub. Date: Sep. 24, 2026

(54) ENERGY STORAGE ELEMENT AND BATTERY

(71) Applicant: VARTA Microbattery GmbH, Ellwangen Jagst (DE)

(72) Inventors: David ENSLING, Ellwangen (DE); Edward PYTLIK, Ellwangen (DE)

(21) Appl. No.: 19/477,510

(22) PCT Filed: Mar. 5, 2024
(86) PCT No.: PCT/EP2024/055749

§ 371 Date: Oct. 22, 2025

(30) Foreign Application Priority Data
Apr. 26, 2023 (DE) 10 2023 110 708.9

(51) Int. Cl. H01M 50/533; H01M 4/133; H01M 4/587; H01M 10/054; H01M 10/0568; H01M 10/0569; H01M 10/0587; H01M 50/119; H01M 50/152; H01M 50/159; H01M 50/184; H01M 50/186; H01M 50/213; H01M 50/342; H01M 50/474; H01M 50/55

(52) U.S. Cl. CPC H01M 50/533; H01M 4/133; H01M 4/587; H01M 10/054; H01M 10/0568; H01M 10/0569; H01M 10/0587; H01M 50/119; H01M 50/152; H01M 50/159; H01M 50/184; H01M 50/186; H01M 50/213; H01M 50/3425; H01M 50/474; H01M 50/55; H01M 2300/004

(57) ABSTRACT

A secondary energy storage element includes a cathode and an anode as parts of an assembly. The cathode and anode are separated by a separator or solid electrolyte layer in a sequence cathode/separator or solid electrolyte layer/anode. The secondary energy storage element further includes a first contact metal sheet and/or a second contact metal sheet. The cathode includes a cathode current collector with a free edge strip that extends along an edge thereof and/or the anode includes an anode current collector with a free edge strip that extends along an edge thereof. The first contact metal sheet is in direct contact with one of the free edge strips and/or the second contact metal sheet is in direct contact with the other of the free edge strips. The electrodes include at least one of sodium ions, potassium ions, calcium ions, magnesium ions, and aluminum ions.

### CROSS REFERENCE TO RELATED APPLICATIONS

This application is a U.S. National Phase application under 35 U.S.C. § 371 of International Application No. PCT/EP2024/055749, filed on Mar. 5, 2024, and claims benefit to German Patent Application No. DE 10 2023 110 708.9, filed on Apr. 26, 2023. The International Application was published in German on Oct. 31, 2024 as WO 2024/223121 under PCT Article 21(2).

### FIELD

The present disclosure relates to an energy storage element suitable for supplying very high currents, and to a method of manufacturing such an energy storage element.

### BACKGROUND

Electrochemical energy storage elements can convert stored chemical energy into electrical energy by virtue of a redox reaction. One of the simplest forms of an electrochemical energy storage element is the electrochemical cell. It comprises a positive and a negative electrode, which are separated from each other by a separator, for example. During discharge, electrons are released at the negative electrode as a result of an oxidation process. This results in an electron current that can be drawn off by an external electrical consumer, for which the electrochemical cell serves as an energy source. At the same time, an ion current corresponding to the electrode reaction occurs within the cell. This ion current crosses the separator and is usually enabled by an ion-conducting electrolyte.

If the discharge is reversible, that is to say if it is possible to reverse the conversion of chemical energy into electrical energy that occurred during discharge and to recharge the cell, the cell is said to be a secondary cell. The common designation of the negative electrode as the anode and the designation of the positive electrode as the cathode in secondary cells refers to the discharge function of the electrochemical cell.

Secondary lithium-ion cells are used as energy storage elements in many applications today because they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components in addition to electrochemically active components.

In principle, any material that can absorb and release lithium ions can be used as an electrochemically active component (active material) for secondary lithium-ion cells. For the negative electrode, carbon-based particles such as graphitic carbon are used, for example. Lithium cobalt oxide (LiCoO₂), lithium manganese oxide (LiMn₂O₄), lithium iron phosphate (LiFePO₄) or derivatives thereof can be used as active materials for the positive electrode. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, as electrochemically inactive components, the electrodes may comprise an electrode binder (e.g., polyvinylidene fluoride (PVDF) or another polymer, for example carboxymethyl cellulose), conductivity-enhancing additives, and other additives. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g., ethers and esters of carbonic acid).

During the manufacture of a lithium-ion cell, the composite electrodes are combined with one or more separators to form an assembly. The electrodes and separators are usually combined under pressure, possibly also by lamination or bonding. The basic functionality of the cell can then be established by impregnating the assembly with the electrolyte.

In many embodiments, the assembly is formed in the form of a winding or processed into a winding. Alternatively, the assembly may also be a stack of electrodes.

Analogous to lithium-ion cells, sodium-ion cells, which use the alkali metal sodium in the form of sodium ions, potassium-ion cells, which use the alkali metal potassium in the form of potassium ions, calcium ion cells, which use the alkaline earth metal calcium in the form of calcium ions, magnesium ion cells, which use the alkaline earth metal magnesium in the form of magnesium ions, and aluminum ion cells, which use aluminum in the form of aluminum ions, can be produced. The structure of the composite electrodes and their further processing can generally be adopted 1:1 for cells with these alternative cell chemistries, whereby current collector materials, electrode materials, electrolytes, and separators tailored to the respective cell chemistry are used.

Sodium-ion cells in particular have in the meantime reached practical maturity. Unlike lithium-ion technology, the production of sodium-ion cells is not limited by scarce resources. However, they have a lower average energy density than lithium-ion cells.

Due to their high energy density, lithium-ion cells are particularly suitable as a power source for electric motors in the automotive sector, but also for e-bikes or other applications with high energy requirements, e.g. for power tools. This requires lithium-ion cells that are optimized to withstand high currents during charging and discharging.

Traditionally, the electrodes are contacted in particular by wound assemblies via metal strips (tabs) which are connected to the current collectors by welding and protrude from the end faces of the wound assemblies, as shown, for example, in FIGS. 1 and 2 of US 2005/0277019 A1. This can be detrimental when high currents occur. Both the tabs and the electrochemically active components of conventional lithium-ion cells have a limited high-current capacity, especially in the charging direction and at low temperatures (<10° C.). Both electrical and thermal gradients occur. Mechanically, too, wound assemblies are disturbed by the tabs, which can lead to unfavorable pressure conditions.

Cylindrical lithium-ion cells are known from WO 2017/215900 A1, in which an assembly is formed from ribbon-shaped electrodes and is present in the form of a winding. The electrodes each have current collectors loaded with electrode material. Oppositely polarized electrodes are arranged offset from each other within the assembly so that longitudinal edges of the current collectors of the positive electrodes protrude from the winding on one side and longitudinal edges of the current collectors of the negative electrodes protrude from the winding on another side. For electrical contacting of the current collectors, the cell has contact plates instead of tabs, which rest on the end faces of the winding and are connected to the longitudinal edges of the current collectors by welding. This makes it possible to electrically contact the current collectors and thus also the associated electrodes over their entire length. This significantly reduces the internal resistance within the cell described. As a result, large currents can be absorbed much better and heat can also be dissipated from the winding more effectively.

Similar cell designs can be found in EP 3916841 A1, EP 3916828 A1, EP 3916827 A1, EP 3916829 A1, EP 3916870 A1, EP 3916869 A1, EP 3916877 A1, EP 3965196 A1 and EP 3916868 A1.

Lithium-ion cells have not yet established themselves on the market as starter batteries for motor vehicles with combustion engines or for some other special applications. Lead-acid batteries, in which the electrodes consist of lead or lead dioxide and the electrolyte consists of diluted sulfuric acid, are still mostly used for these applications. Lead-acid batteries can supply high currents for short periods and perform well even at low temperatures. In addition, they are relatively inexpensive to produce.

However, for environmental reasons, a replacement is urgently needed, as lead is extremely toxic. Although an efficient deposit system for batteries exists in many countries, the release of lead during lead ore mining and subsequent processing, as well as during lead recycling, is sometimes difficult to avoid.

### SUMMARY

In an embodiment, the present disclosure provides a secondary energy storage element. The secondary energy storage element includes a cathode and an anode as parts of an assembly. The cathode and anode are separated by a separator or solid electrolyte layer in a sequence cathode/separator or solid electrolyte layer/anode. The secondary energy storage element further includes a first contact metal sheet and/or a second contact metal sheet. The cathode comprises a cathode current collector and a positive electrode material. The anode comprises an anode current collector and a negative electrode material. In the secondary energy storage element, (i) the cathode current collector comprises a main region loaded on both sides with a layer of the positive electrode material, and a free edge strip that extends along an edge of the cathode current collector and that is not loaded with the positive electrode material, and/or (ii) the anode current collector comprises a main region loaded on both sides with a layer of the negative electrode material, and a free edge strip that extends along an edge of the anode current collector and that is not loaded with the negative electrode material. The cathode and the anode are formed and/or arranged relative to one another within the assembly such that the free edge strip of the cathode current collector protrudes from one side of the assembly and/or the free edge strip of the anode current collector protrudes from another side of the assembly. The first contact metal sheet is in direct contact with one of the free edge strips and/or the second contact metal sheet is in direct contact with the other of the free edge strips. The electrodes comprise at least one ion type from the group comprising sodium ions, potassium ions, calcium ions, magnesium ions, and aluminum ions, which are exchanged between the cathode and the anode during charging and discharging of the secondary energy storage element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an energy storage element of the sodium-ion type (cross-sectional view);

FIG. 2 illustrates a second embodiment of an energy storage element of the sodium-ion type;

FIG. 3 illustrates a third embodiment of an energy storage element of the sodium-ion type (cross-sectional view);

FIG. 4 illustrates several embodiments of a contact metal sheet which is suitable for contacting the first longitudinal edge of the current collector protruding from the first terminal end face of a sodium-ion type energy storage element (perspective view);

FIG. 5 illustrates an assembly that is part of an energy storage element of the sodium-ion type, as well as its components (top view and perspective view);

FIG. 6 illustrates further embodiments of the contact metal sheet which is suitable for contacting the first longitudinal edge of the current collector protruding from the first terminal end face of an energy storage element of the sodium-ion type (perspective view);

FIG. 7 illustrates representations of an embodiment of an energy storage element from the outside and in a longitudinal section;

FIG. 8 illustrates detailed views of the upper and lower end face regions of an embodiment of an energy storage element in a longitudinal section;

FIG. 9 subparts A,B illustrate detailed views of a connection pole for a preferred embodiment of an energy storage element in a view from above at an angle and in a sectional view;

FIG. 10 subparts A,B illustrate detailed views of an insulating disc for a preferred embodiment of an energy storage element as shown in one of FIGS. 7 to 9 in a view from above at an angle and in a sectional view;

FIG. 11 subparts A,B illustrate detailed representations of a contact metal sheet for the preferred embodiment of an energy storage element shown in FIG. 7 in a view from above at an angle and in a sectional view from below at an angle;

FIG. 12 illustrates a detailed representation of the housing bottom of a preferred embodiment of an energy storage element as shown in FIG. 7;

FIG. 13 subparts A-C illustrate representations of the various components of a preferred embodiment of an energy storage element as shown in FIG. 7 in exploded views;

FIG. 14 subparts A,B illustrate detailed views of the upper end face region of a preferred embodiment of an energy storage element, illustrating a possible method of manufacturing the energy storage element;

FIG. 15 illustrates a representation of a preferred embodiment of an energy storage element, viewed obliquely from above onto the housing bottom, to illustrate a method of manufacturing the energy storage element;

FIG. 16 subparts A,B illustrate alternative embodiments of a contact metal sheet with a connection pole attached thereto and its installation in a preferred embodiment of an energy storage element in sectional views; and

FIG. 17 illustrates an example of a lid assembly which can be installed, for example, as a lid in an energy storage element as shown in FIG. 1, FIG. 2, or FIG. 3.

### DETAILED DESCRIPTION

The present disclosure provides energy storage elements which are not inferior to lead accumulators in their performance at low temperatures, but are cheaper than lithium-ion cells and can absorb high currents during charging and deliver them during discharging.

### Energy Storage Element

An energy storage element according to an embodiment has the following features a. to g.:
a. It comprises, as electrodes, a cathode and an anode which are parts of an assembly in which they are present, separated by a separator or solid electrolyte layer, in the sequence cathode/separator or solid electrolyte layer/anode.
b. the cathode comprises a cathode current collector and a positive electrode material,
c. the anode comprises an anode current collector and a negative electrode material,
d. the cathode current collector has
   a main region loaded on both sides with a layer of the positive electrode material, and
   a free edge strip which extends along one edge of the cathode current collector and which is not loaded with the positive electrode material,
      and/or
the anode current collector has
   a main region which is loaded on both sides with a layer of the negative electrode material, and
   a free edge strip which extends along an edge of the anode current collector and which is not loaded with the negative electrode material,
e. the cathode and the anode are formed and/or arranged relative to one another within the assembly in such a way that the free edge strip of the cathode current collector protrudes from one side of the assembly and/or the free edge strip of the anode current collector protrudes from another side of the assembly, and
f. the energy storage element comprises a first contact metal sheet which is in direct contact with one of the free edge strips, and/or a second contact metal sheet which is in direct contact with the other of the free edge strips,
wherein
g. the electrodes comprise at least one ion type from the group comprising sodium ions, potassium ions, calcium ions, magnesium ions, and aluminum ions, which are exchanged between the cathode and the anode during charging and discharging of the secondary energy storage element.

The energy storage element is therefore, in its simplest embodiment, a sodium-ion cell, a potassium-ion cell, a calcium-ion cell, a magnesium-ion cell or an aluminum-ion cell. Among these variants, energy storage elements with sodium-ion cell chemistry are preferred.

When very high currents and/or low temperatures occur, it is essential to minimize any electrical, thermal, and ionic gradients in all electrochemically active components of a cell. The avoidance of ohmic losses plays a decisive role. The lowest possible gradients across the entire assembly, including the electrolyte space, are crucial for service life and current carrying capacity.

The first and/or second contact metal sheet ensures homogeneous electrical and thermal connection of the electrodes of the assembly, in the case of a wound assembly over its entire length, thus leading to improved performance and an increase in service life. The contact metal sheet eliminates the need for tabs for electrode contacting. Accordingly, no mechanical disturbances occur within wound assemblies that could lead to problems under thermomechanical stress.

Surprisingly, it has been found that the design of the energy storage element enables particularly efficient connection of the electrodes of the assembly, especially for the sodium ion system (but also for other post-lithium systems such as the aforementioned systems based on sodium ions, potassium ions, calcium ions, magnesium ions, and aluminum ions). High-performance sodium-ion materials can thus be charged and discharged at a rate of up to 100 C. In addition, sodium-ion systems in particular can also be designed to be resistant to deep discharges.

Energy Storage Element with Wound Assembly

The assembly of the energy storage element can be formed as a winding or as a stack of electrodes. In the wound variant, it has the following features a. to e.:
a. The electrodes and the current collectors as well as the layers made of the electrode materials are ribbon-shaped,
b. It comprises at least one ribbon-shaped separator or at least one ribbon-shaped solid electrolyte layer,
c. the assembly is in the form of a winding in which the electrodes and the at least one separator are wound around a winding axis, wherein the assembly comprises a first and a second terminal end face and a winding shell, and the free edge strip of the cathode current collector protrudes from the first end face and/or the free edge strip of the anode current collector protrudes from the second end face,
d. It comprises a housing, in particular a metal housing, comprising a housing shell or side walls and a bottom and a lid at the end faces, and
e. The assembly formed as a winding is aligned in the housing such that the winding shell bears against the inside of the housing shell or the side walls.

The ribbon-shaped separator forms the separator layer in the assembly.

In this embodiment, the assembly preferably comprises a ribbon-shaped separator or two ribbon-shaped separators, each of which has a first and a second longitudinal edge and two ends.

The winding and the housing are preferred to be cylindrical. The housing then preferably has a circumferential housing shell and a circular bottom and lid. In the cylindrical housing, the assembly formed as a cylindrical winding is preferably aligned axially.

The electrodes and the at least one separator are preferably wound in a spiral around the winding axis.

### Symmetrical and Asymmetrical Winding Contact

The assembly in the form of the winding can be contacted both symmetrically and asymmetrically.

Symmetrical contacting means that
the cathode and the anode of the energy storage element are formed and/or arranged within the assembly in such a way that the free edge strip of the cathode current collector protrudes from one of the end faces of the assembly and the free edge strip of the anode current collector protrudes from the other of the end faces of the assembly, and
the energy storage element comprises a first contact metal sheet which is in direct contact with one of the free edge strips, and a second contact metal sheet which is in direct contact with the other of the free edge strips.

Both electrodes are thus contacted at the two end faces of the winding via contact metal sheets.

Asymmetrical contacting means that
the cathode and the anode of the energy storage element are formed and/or arranged within the assembly in such a way that either only the free edge strip of the cathode current collector or only the free edge strip of the anode current collector protrudes from one of the end faces of the assembly, and
the energy storage element comprises only one contact metal sheet which is in direct contact with the free edge strip of the cathode current collector or the anode current collector protruding from the assembly.

In this embodiment, only one of the electrodes is contacted at one of the two end faces of the assembly via a contact metal sheet. Preferably, at least one metallic conductor strip (tab) is fixed to the current collector of the other electrode, which protrudes from the other of the terminal end faces of the assembly.

In the case of asymmetrical contacting, the energy storage element has one of the immediately following features a. to c.:
a. The at least one metallic conductor strip is connected by welding to the lid or to a metallic pole passing through the lid, while the free edge strip protruding from one of the end faces is welded to the bottom or to a metal sheet resting directly on the bottom of the housing (variant A),
or
b. the at least one metallic conductor strip is welded to the bottom, while the free edge strip protruding from one of the end faces is connected by welding to the lid or to a pole passing through the lid (variant B).
or
c. the at least one metallic conductor strip is welded to the bottom, while the free edge strip protruding from one of the end faces is connected by welding to a pole passing through the lid or to a metal sheet resting on the free edge strip and electrically coupled to the lid or the pole (variant C).

In variant B, the bottom of the housing acts as a contact metal sheet, which can be particularly advantageous since, in this embodiment, optimum heat dissipation of the electrode coupled via the free edge strip can be achieved.

It is particularly advantageous if the anode current collector is connected directly to the bottom according to variant B, while the cathode current collector is connected via the tab. The simultaneous use of the conductor strip on the end face of the winding facing the lid, with simultaneous connection of the anode via, ideally, the entire longitudinal edge of its current collector, can offer volumetric advantages that are particularly beneficial in energy-optimized cells. At the same time, positive effects result from the excellent connection of the anode and thus improved performance and service life of the cell. In particular, a homogeneous electrical and thermal connection of the anode is advantageous for improved fast charging capability. In this context, it should be specifically mentioned that sodium-ion electrolytes generally have higher conductivities than their lithium counterparts and therefore offer advantages in terms of thick or highly loaded electrodes, fast charging (>2 C) and performance at low temperatures (<0° C.).

### Preferred Further Embodiments of the Energy Storage Element with Wound Assembly

In energy storage elements with a wound assembly, the contact metal sheet(s) preferably lie flat on the one or two end faces, preferably in such a way that the free edge strips are in contact with the contact metal sheets over their entire length. In practice, however, this is often not achievable.

The energy storage element with a wound assembly is preferred because it has the immediately following feature a.:
a. The metal housing comprises a cup-shaped, cylindrically formed housing part with a terminal, preferably circular opening and a lid which closes the terminal opening of the cup-shaped housing part.

In many preferred embodiments, the lid comprises several components. For example, the lid may comprise a bursting membrane and/or be equipped with a CID function (CID=Current Interrupt Device).

The lid preferably has a circular circumference and is arranged in the circular opening of the cup-shaped housing part in such a way that the edge rests against the inside of the cup-shaped housing part along a circumferential contact zone, wherein the edge of the lid is connected to the cup-shaped housing part by a circumferential weld seam. In this case, the two housing parts preferably have the same polarity and are therefore electrically coupled to either a positive or a negative electrode. In this case, the housing also comprises a pole bushing which serves to electrically contact the electrode which is not electrically connected to the housing.

In an alternative embodiment, an electrically insulating seal is fitted to the edge of the lid, which electrically separates the lid from the cup-shaped housing part. In this case, the housing is usually sealed by a crimp closure.

The height of energy storage elements formed as cylindrical round cells is preferably in the range from 50 mm to 150 mm. The diameter of the cylindrical round cells is preferably in the range from 15 mm to 100 mm.

In embodiments in which the energy storage element is a cylindrical round cell, the anode current collector, the cathode current collector and the separator or separators or the solid electrolyte layer preferably have the following dimensions:
A length in the range from 0.3 m to 25 m
A width in the range from 30 mm to 145 mm

In this embodiment, the contact metal sheets preferably have a circular basic shape.

### Prismatic Embodiment

In the prismatic embodiment, the energy storage element has the immediately following features a. to c., preferred the immediately following features a. to d.:
a. The assembly is in the form of a prismatic stack in which the cathode and the anode are stacked together with further cathodes and anodes.
b. The electrodes and the current collectors as well as the layers made of the electrode materials are formed as polygons, in particular as rectangles.
c. It comprises at least one ribbon-shaped or polygonal, in particular a rectangular, separator or at least one ribbon-shaped or polygonal, in particular rectangular, solid electrolyte.
d. The stack is enclosed by a prismatic housing.

In the stack, adjacent electrodes with opposite polarities are always separated from each other by a separator or solid electrolyte layer.

The prismatic housing is preferably composed of a cup-shaped housing part with a terminal opening and a lid. In this embodiment, the bottom of the cup-shaped housing part and the lid preferably have a polygonal, preferably a rectangular base area. The shape of the terminal opening of the cup-shaped housing part corresponds to the shape of the bottom and the lid. In addition, the housing comprises several, preferably four, rectangular side parts which connect the bottom and the lid to each other.

Prismatic cells can also be constructed as so-called pouch cells. Instead of the metal housing parts, composite films are used, which are formed into the appropriate shape by a deep-drawing process. The current conductors are led to the outside via the regions in which the composite films are thermally welded/sealed.

The separator layers can be formed by several separators, each arranged between adjacent electrodes. However, it is also possible for a ribbon-shaped separator to separate the electrodes of the stack from each other. In the case of several separators between the anodes and cathodes, the separators preferably also have a polygonal, in particular rectangular, base area.

In this embodiment, the contact metal sheets preferably have a rectangular shape.

In some preferred variants of the prismatic embodiment, the energy storage element has at least one of the immediately following features a. and b.:
a. The free edge strips of the cathode current collectors of the cathodes of the stack protrude from one side of the stack and are in direct contact with the first contact metal sheet.
b. The free edge strips of the anode current collectors of the anodes of the stack protrude from another side of the stack and are in direct contact with the second contact metal sheet.

Preferably, the immediately preceding features a. and b. are implemented in combination with each other.

In further preferred variants of the prismatic embodiment, the energy storage element has at least one of the immediately following features a. and b.
a. The free edge strips of the cathode current collectors are arranged parallel to each other.
b. The free edge strips of the anode current collectors are arranged parallel to each other.

The immediately preceding features a. and b. are preferably realized in combination with each other.

### Preferred Electrochemical Embodiment and Electrolyte

In a further preferred embodiment, the energy storage element is characterized by one of the following features:
a. The energy storage element is a sodium ion cell.
b. The energy storage element comprises a sodium-ion cell.
c. The energy storage element comprises one of the following electrolytes:
   NaClO₄ dissolved in at least one organic solvent, in particular in PC or in a carbonate mixture from the group comprising EC/DEC/FEC and PC/FEC.

The concentration of NaClO₄ in the electrolyte is preferably 0.3-5 M, preferably 0.7 M-1.7 M.

In a mixture of EC/DEC/FEC, the three components are preferably contained in the electrolyte in a volume ratio in the range from 1:2 to 2:1, in particular 1:1:0.5.

In the case of a mixture comprising EC/DEC, the components are preferably contained in the electrolyte in a volume ratio in the range from 1:2 to 2:1.
NaPF₆ and/or NaTFSI (sodium bis(trifluoromethane sulfonyl)imide) dissolved in at least one organic solvent, in particular in PC or in a carbonate mixture from the group comprising EC/DEC/FEC, EC/PC, EC/DEC, FEC/EMC and PC/FEC or in an ether mixture such as THF/mTHF.

The concentration of NaPF₆ and/or NaTFSI in the electrolyte is preferably 0.3-5 M, preferably 0.7 M-1.7 M.

In an EC/PC mixture, the two components are preferably present in the electrolyte in a volume ratio in the range from 1:2 to 2:1.

In an EC/DEC mixture, the two components are preferably present in the electrolyte in a volume ratio in the range from 1:2 to 2:1.

In a mixture of FEC/EMC, the two components are preferably contained in the electrolyte in a volume ratio in a range from 1:2 to 2:1, in particular in a ratio of 3:7.

If necessary, the electrolyte may contain up to 10% FEC.
NaFSI and/or NaTFSI and/or NaTDI dissolved in at least one organic solvent, in particular in 1,4-dioxane (DX) and/or 1,3-dioxolane (DOL) and/or dimethyl ether (DME).

The concentration of NaFSI and/or NaTFSI and/or NaTDI in the electrolyte is preferably 0.3-5 M, preferably 0.7 M-1.7 M.
NaFSI and/or NaTFSI and/or NaTDI dissolved in at least one organic solvent, in particular in dimethyl carbonate (DX) and/or tris(2,2,2-trifluoroethyl) phosphate (TFP).

The concentration of NaFSI and/or NaTFSI and/or NaTDI in the electrolyte is preferably 0.5-2.5 M, preferably 1 M-2 M.

In an EC/PC mixture, the components are preferably contained in the electrolyte in a volume ratio in the range from 1:2 to 2:1.

The liquid components are preferably contained in the electrolyte in a volume ratio in the range from 1:2 to 2:1.
NaN(SO₂F)₂ dissolved in at least one organic solvent, in particular in 1,4-dioxane (DX) and/or 1,3-dioxolane (DOL) and/or dimethyl ether (DME).

The concentration of NaN(SO₂F)₂ in the electrolyte is preferably 0.3-5 M, preferably 0.7 M-1.7 M.

In a DX/DOL mixture, the components are preferably contained in the electrolyte in a volume ratio in the range from 1:2 to 2:1.
NaBF₄ dissolved in at least one organic solvent, in particular in tetraethylene glycol dimethyl ether (TEGDME) and/or in ACN and/or in PC and/or GBL.

The concentration of NaBF₄ in the electrolyte is preferably 0.3-5 M, preferably 0.7-1.7 M.

An electrolyte with NaBF₄ in TEGDME is particularly suitable for cells with a sodium metal anode (see below).

The features a. and c. as well as b. and c. in combination with each other are preferred.

Feature a. relates in particular to the described embodiment of the energy storage element as a cylindrical round cell. In this embodiment, the energy storage element preferably comprises exactly one electrochemical cell.

Feature b. relates in particular to the prismatic embodiment of the energy storage element described above. In this embodiment, the energy storage element may also comprise more than one electrochemical cell.

Preferably, the energy storage element based on sodium ions further comprises an electrolyte comprising at least one of the following solvents and at least one of the following conductive salts:

Preferred solvents are:
Carbonates: propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC)
Ethers: Tetrahydrofuran (THE), 2-methyltetrahydrofuran, dimethyl ether (DME), 1,4-dioxane (DX), 1,3-dioxolane (DOL), diethylene glycol dimethyl ether (DEGDME), tetraethylene glycol dimethyl ether (TEGDME)
Nitriles: Acetonitrile (ACN), adiponitrile (AON), y-butyrolactone (GBL)
Trimethyl phosphate (TMP) and tris(2,2,2-trifluoroethyl) phosphate (TFP) may also be considered.

Preferred conductive salts are:
NaPF₆, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis(trifluoromethane sulfonyl)imide (NaTFSI), NaAsF₆, NaBF₄, NaClO₄, NaB(C₂O₄)₂, NaP(C₆H₄O₂)₃, NaCF₃SO₃, sodium triflate (NaTf) and Et₄NBF₄.

Like the solvents, the conductive salts can also be used as a mixture of two or more main salts.

In preferred embodiments additives may be added to the electrolyte. Examples of preferred additives, in particular for stabilization, are the following:

Fluoroethylene carbonate (FEC), trans-difluoroethylene carbonate (DFEC), ethylene sulfite (ES), vinyl carbonate (VC), bis(2,2,2-trifluoroethyl) ether (BTFE), sodium 2-trifluoromethyl-4,5-dicyanoimidazole (NaTDI), sodium bis(fluorosulfonyl)imide (NaFSI), aluminum chloride (AICI(₃₎₎, ethylene sulfate (DTD), sodium difluorophosphate (NaPO₂F₂), sodium difluoro(oxalato)borate (NaODFB), sodium difluorobisoxalate phosphate (NaDFOP) and tris(trimethylsilyl)borate (TMSB).

Instead of liquid electrolytes with the aforementioned conductive salts, ionic liquids can also be used, e.g. 0.8 mol/l sodium bis(fluorosulfonyl)imide (Na-TFSI) in 1-methyl-1-propylpyrrolidinium bis(trifluoromethylsulfonyl)imide (PMPyrr-TFSI).

Sodium polymer electrolytes are another alternative, for example polymer electrolytes based on polyethylene oxide (PEO) or polyvinylidene difluoride hexafluoropropylene, such as P(EO)₈NaCF₃SO₃ or hydroxyethyl cellulose polyethylene oxide.

In place of liquid electrolytes based on organic solvents, aqueous sodium electrolytes with anions from the group with OH⁻, NO₃⁻, CI⁻ and SO₄²⁻ an also be used in special applications, or aqueous solutions of NaFSI, NaTDI or NaTFSI.

### Preferred Embodiments of the Electrode Materials

The negative electrode material of an energy storage element based on sodium ions is preferably at least one of the following materials:
Carbon, particularly hard carbon (pure or with nitrogen and/or phosphorus doping) or soft carbon or graphene-based materials (with N doping); carbon nanotubes, graphite
phosphorus or sulfur (conversion anode)
Polyanions: Na₂Ti₃O₇, Na₃Ti₂(PO₄)₃, TiP₂O₇, TiNb₂O₇, Na—Ti—(PO₄)₃, Na—V—(PO₄)₃ or Na-M-PO₄—P₂O₇ with M=V, Ti, Fe, Co, Ni, Mn, or mixtures of 3d transition metals and added doping elements such as Al, Cu, Zn
Na₄M₃(PO₄)₂(P₂O₇) with M=Na, Zn, Al, Mg, or Ca
Sn- or Sb-based materials such as Sn(Na₁₅Sn₄), Sb(Na₃Sb), SnO₂, Sb₂O₃
Prussian blue: low-Na variant (for systems with aqueous electrolyte)
Transition metal oxides: V₂O₅, MnO₂, TiO₂, Nb₂O₅, Fe₂O₃, Na₂Ti₃O₇, NaCrTiO₄, Na₄Ti₅O₁₂
MXenes with M=Ti, V, Cr, Mo or Nb and A=AI, Si, and Ga as well as X=C and/or N, e.g. Ti₃ C₂
Organic: e.g., sodium terephthalates (Na₂C₈H₂O₄)

An exemplary overview of suitable anode materials can also be found in the publication by Zhang et al., “SODIUM-ION BATTERY ANODES: STATUS AND FUTURE TRENDS,” EnergyChem 1, 100012 (2019) from 2019 in Table 2 on page 19.

Alternatively, a sodium metal anode may also be used on the anode side. The metallic sodium is preferably embedded in a porous, electrically conductive matrix structure with good sodium wettability. Minimal electrical, thermal, and mechanical gradients are of great importance in this context; these are enabled in the inventive cell by the design featuring face-side contacting of the electrode winding.

The positive electrode material of an energy storage element based on sodium ions is preferably at least one of the following materials:
Polyanions: NaFePO₄ (triphylite type), Na₂Fe—(P₂O₇), Na₄Fe₃(PO₄)₂ (P₂O₇), Na₂FePO₄F, Na/Na₂ [Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Prussian blue/white: Prussian blue (PB) exists in the form of AₓFe[Fe(CN)₆]_{1-y}*nH₂O with A=alkali metal and 0<x<2 und y<1; Prussian white (Na~2) in the form of Na₂Fe[Fe(CN)₆], KFe₂(CN)₆, MnFe(CN)₆ and Fe₂(CN)₆
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

Blends of the positive electrode materials mentioned are also usable.

In addition, the electrodes of an energy storage element preferably contain an electrode binder and/or an additive to improve electrical conductivity. The active materials are preferably embedded in a matrix of the electrode binder, wherein the active materials are preferably used in particulate form and adjacent particles in the matrix are preferably in direct contact with one another. Conductive agents have the function of increasing the electrical conductivity of the electrodes. Conventional electrode binders are based, for example, on polyvinylidene fluoride (PVDF), (Na) polyacrylate, styrene-butadiene rubber, (Na) alginate or carboxymethyl cellulose, or mixtures of different binders. Conventional conductive agents are carbon black, fine graphite, carbon fibers, carbon nanotubes and metal powders.

The following material combinations are preferred for sodium-ion-based energy storage elements
Positive electrode: Na₃V₂(PO₄)₃
Negative electrode: Hard carbon
Electrolyte: Preferably NaPF₆ in EC:PC:DMC (45:45:10 vol. %)
Positive electrode: Na_{2/3}(Ni_{1/3}Mn_{2/3})O₂
Negative electrode: Hard carbon
Positive electrode: Na₂Fe[Fe(CN)₆]
Negative electrode: Hard carbon
Electrolyte: Preferably NaPF₆ in EC:PC

### Ion Deposit

The function of a sodium, potassium, calcium, magnesium or aluminium ion cell is based on the availability of sufficient mobile ions (in the case of a sodium ion cell, for example, mobile sodium ions) to balance the drawn-off electrical current by migrating between the anode and the cathode or the negative electrode and the positive electrode. In the context of this application, mobile ions are understood to mean that the ions are available for storage and retrieval processes in the electrodes during the discharge and charging processes of the energy storage element, or can be activated for this purpose. In the course of the discharge and charge processes, e.g. of a sodium-ion cell, losses of mobile sodium occur over time. These losses occur as a result of various, generally unavoidable side reactions. Losses of mobile sodium already occur during the first charge and discharge cycle of a sodium-ion cell. During this first charging and discharging cycle, a cover layer generally forms on the surface of the electrochemically active components at the negative electrode. This cover layer is referred to as the solid electrolyte interphase (SEI) and generally consists mainly of electrolyte decomposition products and a certain amount of sodium that is firmly bound in this layer.

In order to compensate for these losses, the sodium-ion-based energy storage element is characterized in preferred embodiments by at least one of the immediately following features a. and b.:
a. The energy storage element comprises a deposit of sodium or a sodium-containing material not enclosed by the positive and/or negative electrode, with which losses of mobile sodium during operation can be compensated.
b. The deposit is in contact with the electrolyte of the energy storage element.

It is preferred that the immediately preceding features a. and b. are realized in combination with each other.

Particularly suitable sodium-containing materials are, for example, Na₃N, Na₂C₂O₄, Na₂S, Na₂C₄O₄, Na₂C₆O₆, EDTA-4Na, DPTA-5Na, Na₃P or C₁₂H₉Na (sodium biphenyl). These materials can be added to the electrode active material, for example. An additional Na source leads to higher capacity or longer cycle life.

It is also conceivable that the electrodes could be precharged with an excess of sodium ions.

The same applies to embodiments of the energy storage element based on potassium, calcium, magnesium or aluminum ions.

### Preferred Embodiment of a Sodium Metal Anode

As mentioned above, a sodium metal anode can also be used on the anode side, in which the metallic sodium is preferably embedded in an electrically conductive matrix structure.

In further embodiment, it may be preferred that the energy storage element is characterized by at least one of the following features:
a. The anode comprises a matrix with depressions and/or pores in which metallic sodium is stored.
b. The matrix adheres to the surface of the anode current collector.
c. The matrix comprises carbon particles and a binder.
d. The matrix comprises conductive agents and/or fillers.
e. The matrix is a roughened surface of the anode current collector.

It is preferred that the immediately preceding features a. to d. or a. and d. are realized in combination with each other.

The carbon particles, conductive agents or fillers are, for example, hard carbon, activated carbon, conductive graphite, carbon black, carbon nanotubes, graphene or graphene oxide, or finely dispersed metals such as Ag, Cu, Al, Ni or Pt. For example, the carbon particles may comprise 20-80 wt % hard carbon and 80-20 wt % carbon black and 0-10 wt % silver, it being preferred that the weight proportions of the components add up to 100 wt %.

The binder can basically be any binder that is also suitable for the production of composite electrodes for lithium-ion batteries. Suitable examples include polyvinylidene fluoride (PVDF) or another polymer, such as carboxymethyl cellulose or a derivative thereof.

The carbon-based matrix may comprise doping elements such as boron, oxygen, fluorine or nitrogen.

The carbon-based matrix is preferably 500 nm to 250 μm thick.

The surface of the anode current collector can be roughened, for example by laser treatment.

Furthermore, it may be preferred that the energy storage element is characterized by at least one of the following features:
a. The anode comprises, in particular in place of the matrix, a nucleation layer in which metallic sodium is stored and/or on which metallic sodium is deposited.
b. The nucleation layer consists essentially of at least one material from the group comprising tin, silver, gold, germanium, carbon, platinum, zinc, aluminum, magnesium, and silicon.
c. The nucleation layer has been deposited on the surface of the anode current collector by means of PVD (physical vapor deposition) or CVD (chemical vapor deposition).

The nucleation layer made of tin, silver, gold, germanium, and/or carbon facilitates the deposition of sodium. Carbon, silver, gold, platinum, zinc, aluminum, magnesium, tin, and silicon reduce overvoltage.

The nucleation layer may also comprise doping elements such as boron, oxygen, fluorine or nitrogen.

The nucleation layer is preferably 100 nm to 50 μm thick.

It is preferred that the matrix and/or the nucleation layer account for less than 30 wt. %, preferably less than 5 wt. %, of the dry weight of the negative electrode.

To make an electrode with the matrix or nucleation layer, it's best to use an anode current collector with the matrix or nucleation layer, but without any metallic sodium. The sodium is best deposited in and/or on the matrix or nucleation layer during an initial charging process. The sodium needed is best supplied via the cathode. For example, Na₃V₂(PO₄)₃ can be used as a positive electrode material for this purpose. Alternatively, the sodium deposition can also be carried out by pre-sodization. This procedure prevents dendritic growth. Furthermore, it ensures that there is no undesirable excess sodium in the electrodes.

It may be useful to provide a degassing option during the first charging process so that excessive pressure does not build up in the housing of the energy storage element.

A ratio of anode capacity to cathode capacity in the range from 0.7 to 1.2 is preferred.

The energy storage element is preferred in that it has the immediately following features:

It is preferred that the nucleation layer and/or the matrix is covered with a cover layer. The negative electrode thus preferably comprises the following layer sequence:
Metal current collector
Matrix or nucleation layer
Cover layer

The matrix or nucleation layer is thus arranged between the cover layer and the current collector.

The cover layer preferably has a thickness in a range from 300 nm to 30 μm.

The cover layer is preferably formed from a ceramic material or comprises such a ceramic material. The ceramic material is preferably aluminum oxide (Al₂O₃), aluminum hydroxide or aluminum oxide hydroxide (AlOOH), silicon oxide (SiOₓ with x in the range from >1 and ≤2), titanium oxide (TiO₂), titanium nitride (TiN), titanium aluminum nitride (TiAlN) or titanium carbonitride (TiCN).

In further possible preferred embodiments, the cover layer is formed from a superionic conductor of the chemical formula Na₁₊ₓZr₂SiₓP₃₋ₓO₁₂ (where 0<x<3) or comprises such an ionic conductor.

In further possible preferred embodiments, the cover layer is formed from a polymer, in particular a polysiloxane, a polyethylene oxide, a perfluoropolyether or a polyacrylonitrile, or comprises such a polymer.

If the cover layer comprises the ceramic material, it further comprises a binder in preferred embodiments. This binder can basically be a binder that is also suitable as a binder for the active material, for example carboxymethyl cellulose.

### Preferred Embodiments of the Separator and the Solid Electrolyte

The separator or separators are preferably formed from electrically insulating plastic films. It is preferred that the separators can be penetrated by the electrolyte. For this purpose, the plastic films used may, for example, have micropores. The film may consist, for example, of a polyolefin or a polyether ketone. Nonwovens and fabrics made of plastic materials or other electrically insulating flat structures may also be used as separators. Separators with a thickness in the range from 5 μm to 50 μm are preferred.

Separators made of cellulose-based materials can also be used. These offer good wettability and high temperature stability.

In particular in the prismatic embodiments of the energy storage element, the separator or separators of the assembly may also be one or more layers of a solid electrolyte.

The solid electrolyte may be, for example, a polymer solid electrolyte based on a polymer-conducting salt complex, which is present in a single phase without any liquid components. As a polymer matrix, a polymer solid electrolyte may comprise, for example, polyacrylic acid (PAA), polyethylene glycol (PEG) or polymethyl methacrylate (PMMA), in particular also polyethylene oxide (PEO). In the case of a sodium ion cell, sodium conductive salts such as sodium bis(trifluoromethane)sulfonylimide (NaTFSI), sodium hexafluorophosphate (NaPF₆) and sodium tetrafluoroborate (NaBF₄) may be present in dissolved form.

### Ceramic Reinforcement of the Separator

Other preferred designs of the separator may be appropriate in individual cases. The energy storage element is preferably further characterized by at least one of the immediately following features a. and b.:
a. The side of the assembly from which the free edge strip of the cathode current collector or the free edge strip of the anode current collector protrudes from is formed by an edge of the separator, in the case of an energy storage element with a wound assembly, in particular a longitudinal edge of the separator.
b. The edge or longitudinal edge of the separator which forms the side, in particular the end face, is reinforced with ceramic.

In a preferred further embodiment, the energy storage element has the immediately following feature a.:
a. The ceramic reinforcement is effected by at least one particulate ceramic material, in particular at least one particulate ceramic filler material in the separator.

The separator may therefore preferably be an electrically insulating plastic film in which the particulate filler material is embedded. It is preferable that the plastic film can be penetrated by the electrolyte, for example because it has micropores. The film can be made, for example, from a polyolefin or a polyether ketone. As mentioned, nonwovens and fabrics made from such plastic materials can also be used. These may also be preferred in individual cases.

The proportion of the particulate filler material in the separator is preferably at least 40% by weight, preferably at least 60% by weight.

In a further preferred further embodiment, the energy storage element has the immediately following feature a.:
a. The ceramic reinforcement is effected by at least one particulate ceramic material which is present as a coating on a surface of the separator or separators.

The separator may therefore preferably also be a plastic film or a nonwoven fabric or a woven fabric or any other electrically insulating sheet material coated with a ceramic material.

In some embodiments, only one side of the flat structure, in particular the plastic film, is coated with the ceramic material. In further embodiments, the flat structure, in particular the plastic film, is preferably coated on both sides with the ceramic material.

If necessary, it may also be preferred that the separators used comprise a ceramic material as filling material and the same or a different ceramic material as coating.

In further possible preferred embodiments, the energy storage element has at least one of the immediately following features a. to e.:
a. The at least one ceramic material/filling material is or comprises an electrically insulating material.
b. The at least one ceramic material/filler material is or comprises at least one material from the group comprising glass-ceramic material and glass.
c. The at least one ceramic material/filler material is or comprises a sodium ion-conducting ceramic material, for example Na₅AlO₄*Na₄SiO₄ or NaAlSi₂O₆ or β-Al₂O₃ or a NASICON material such as Na₃Zr₂Si₂PO₁₂.
d. The at least one ceramic material/filler material is or comprises an oxidic material, in particular a metal oxide.
e. The ceramic or oxidic material is aluminum oxide (Al₂O₃), silicon oxide (SiOₓ), in particular silicon dioxide (SiO₂), titanium oxide (TiO₂), titanium nitride (TiN), titanium aluminum nitride (TiAlN), a silicon oxide, in particular silicon dioxide (SiO₂), or titanium carbonitride (TiCN).

It is preferred that the immediately preceding features a. to c. or the immediately preceding features a. and b. and d. or the immediately preceding features a. and b. and e. are realized in combination with each other.

Among the materials mentioned, aluminum oxide (Al₂O₃), aluminum hydroxide (Al(OH)₃), aluminum oxide hydroxide (AlOOH), titanium oxide (TiO₂), and silicon dioxide (SiO₂) are preferred as coating materials.

In further possible preferred embodiments, the energy storage element has at least one of the immediately following features a. and b.:
a. The separator or separators comprise the at least one ceramic material only in some areas.
b. The separator or separators have an edge strip along the edge forming the first side, in particular the first end face, in which they comprise the at least one ceramic material as a coating and/or as a particulate filling material.

It is preferred that the immediately preceding features a. and b. are realized in combination with each other.

It is by no means essential that the separator comprises the ceramic material in homogeneous distribution or is coated uniformly and everywhere with the material. Rather, it may even be preferred that the separator is free of the ceramic material in certain regions, for example in the aforementioned main region. In this region, increased thermal resistance of the separator is not as necessary as at the edges of the separator. Furthermore, the ceramic material can contribute to an undesirable elevation of the internal resistance of the energy storage element, particularly in this region.

In many embodiments, however, the separator is preferably reinforced or coated with the ceramic material over its entire surface, i.e. also between the anode and cathode.

The front electrode areas without active material coating could be coated in whole or in part with ceramic materials to reduce the risk of short circuits.

Further details on coatings of separators with ceramic materials can be found in WO 2021/255238 A1.

### Preferred Embodiments of the Current Collectors

The current collectors of the electrodes of the energy storage element have the function of electrically contacting the electrochemically active components contained in the respective electrode material over as large an area as possible. Preferably, the current collectors consist of a metal or are at least metallized on the surface.

In particular, in the case of an energy storage element based on sodium ions, aluminum or an aluminum alloy are suitable as metallic materials for both the anode current collector and the cathode current collector. Sodium-ion systems that have current collectors made of aluminum or an aluminum alloy on both the anode and cathode sides have proven to be particularly resistant to the effects of deep discharges.

Suitable aluminum alloys for the cathode current collector are, for example, Al alloys of types 1235, 1050, 1060, 1070, 3003, 5052, Mg3, Mg212 (3000 series) and GM55. AlSi, AlCuTi, AlMgSi, AlSiMg, AlSiCu, Al—CuTiMg, and AlMg are also suitable. The aluminum content of these alloys should preferably be above 99.5%.

The anode current collector and/or the cathode current collector is preferably a ribbon-shaped metal foil with a thickness in the range from 4 μm to 30 μm.

In addition to foils, however, other ribbon-shaped substrates such as metallic or metallized nonwovens or open-pored metallic foams or expanded metals can also be used as current collectors.

The current collectors are preferably loaded with the respective electrode material on both sides.

### Edge Reinforcement of the Current Collector(s)

The energy storage element is preferably further characterized by at least one of the immediately following features a. to c.:
a. In the free edge strip of the cathode current collector and/or in the free edge strip of the anode current collector, the surface of the cathode current collector and/or of the anode current collector is coated with a support material which is more thermally resistant than the surface coated therewith.
b. The non-metallic material is a ceramic material, a glass-ceramic material, or a glass.
c. The ceramic material is aluminum oxide (Al₂O₃), aluminum hydroxide (Al(OH)₃), aluminum oxide hydroxide (AlOOH), titanium oxide (TiO₂), titanium nitride (TiN), titanium aluminum nitride (TiAlN), or titanium carbonitride (TiCN).

“Thermally resistant” means that the support material remains in a solid state at a temperature at which the surface melts. It therefore either has a higher melting point than the surface or sublimates or decomposes only at a temperature at which the surface has already melted.

Preferably, both the free edge strip of the cathode current collector and the free edge strip of the anode current collector are coated with the support material. It is preferred to use the same support material in each case.

The contact metal sheets that are in direct contact with the free edge strip(s) are preferably connected to the edge strips by welding. This can lead to problems, namely unintentional pressing down or melting of the edge strips of the current collectors. The support material counteracts these problems. It mechanically supports the edge strips of the current collectors and prevents the edges from melting, especially if the edge strips are coated on both sides with the support material. Furthermore, the support material also prevents short circuits resulting from the melting of separators of the assembly mentioned above. The support material electrically insulates the free areas covered by it. In preferred embodiments, it is therefore formed as electrically insulating.

Further details on suitable support materials can be found in WO 2020/239512 A1.

In preferred embodiments, the support material covers not only the edge strip or part of the edge strip of the anode current collector, but also the electrode material arranged on the anode current collector in the main area. The layer of support material can thus also function as a cover layer, covering, for example, the matrix described above or the nucleation layer described above. This is preferably the case when the support material is one of the ceramic materials mentioned.

The support layer may also comprise a binder which, for example, holds together ceramic particles of the support layer.

### Preferred Embodiments of the Assembly

In order to prevent direct contact between oppositely polarized electrodes at the axial ends of a winding or stack, separators that are slightly wider than the electrodes to be separated are preferably used. In an energy storage element with a wound assembly, the assembly thus terminates at its axial ends in preferred embodiments with a separator projection which accordingly forms the end faces.

In the case of the prismatic configuration described, it is preferable that the edges of the separator or separators form the sides of the stack from which the free edge strips of the current collectors protrude.

It is further preferred that the free edge strips of the current collectors protruding from the terminal end faces of the winding or sides of the stack do not protrude more than 5500 μm, preferably not more than 4000 μm, from the end faces or sides.

It is preferred that the free edge strip of the anode current collector protrudes no more than 3000 μm, preferably no more than 2000 μm, from the side of the stack or the end face of the winding. It is preferred that the free edge strip of the cathode current collector protrudes no more than 4000 μm, preferably no more than 3000 μm, from the side of the stack or the end face of the winding.

In the wound assembly, the ribbon-shaped anode, the ribbon-shaped cathode and the ribbon-shaped separator or separators are preferably wound in a spiral. To produce the assembly, the ribbon-shaped electrodes are preferably fed together with the ribbon-shaped separator(s) to a winding device and preferably wound spirally around a winding axis therein. In some embodiments, the electrodes and the separator or separators are wound for this purpose onto a cylindrical or hollow cylindrical winding core which rests on a winding mandrel and remains in the winding after winding.

The winding shell can be formed, for example, by a plastic film or an adhesive tape. It is also possible for the winding shell to be formed by one or more separator windings.

### Preferred Embodiments of the First and/or Second Contact Metal Sheet

The contact metal sheet or sheets are preferably connected to the respective current collectors with which they are in direct contact by welding. It is preferred that they are connected directly to the free edge strip of the anode current collector by welding.

In preferred embodiments, the contact metal sheets consist of the same material as the current collectors to which they are connected by welding.

In preferred embodiments, the contact metal sheets, especially in the case of sodium-ion-based energy storage elements, consist of aluminum or an aluminum alloy.

The same alloys mentioned in connection with current collectors made of an aluminum alloy are suitable as aluminum alloys.

In other preferred embodiments, the contact metal sheets consist, for example, of nickel or copper or titanium or a nickel or copper or titanium alloy or stainless steel.

In a further preferred embodiment, the first contact metal sheet has at least one of the immediately following features a. to g.:
a. The contact metal sheet has a preferably uniform thickness in the range from 50 μm to 600 μm, preferably in the range from 150 μm to 350 μm.
b. The contact metal sheet has two opposite flat sides and extends essentially only in one dimension.
c. The contact metal sheet is a disc or preferably a rectangular plate.
d. The contact metal sheet is dimensioned such that it covers at least 60%, preferably at least 70%, and preferably at least 80% of the side or end face from which the free edge strip of the respective current collector connected to it emerges.
e. The contact metal sheet has at least one aperture, in particular at least one hole and/or at least one slot.
f. The contact metal sheet has at least one bead which appears on one flat side of the contact metal sheet as an elongated depression and on the opposite flat side as an elongated elevation, wherein the contact metal sheet rests on the free edge strip of the respective current collector with the flat side which carries the elongated elevation.
g. The contact metal sheet is welded to the free edge strip of the current collector in the region of the bead, in particular via one or more weld seams and/or weld spots arranged in the bead.

It is preferred that the immediately preceding features a. and b. and d. are realized in combination with each other. In a preferred embodiment, the features a. and b. and d. are realized in combination with one of the features c. or e. or the features f. and g. All features a. to g. realized in combination with each other are preferred.

Covering as much of the end face as possible is important for the thermal management of the energy storage element. The larger the cover, the easier it is to contact the first edge of the current collector over its entire length. Heat generated in the assembly can thus be dissipated effectively via the contact metal sheet.

It is particularly advantageous if the contact metal sheet is in direct contact with all windings of a winding, i.e. also with the innermost and outermost windings of the winding.

The at least one aperture in the contact metal sheet may be useful, for example, in order to be able to soak the assembly with an electrolyte.

### Electrical Connection of the Contact Metal Sheet(s)

The contact metal sheet is
either electrically connected to the housing or
connected to a contact pole which is guided through the housing and electrically insulated from the housing, or
the contact metal sheet is part of the housing, for example the bottom of a cup-shaped housing part or the lid for such a cup-shaped housing part.

The electrical contact to the housing or the contact pole can be realized in particular by welding or a mechanical connection. If necessary, the electrical connection can also be made via a separate electrical conductor.

For optimum connection of the contact metal sheet or sheets to the current collectors, it may be preferable to subject the sides or end faces to mechanical pretreatment. For example, the edges of the current collectors protruding from the end faces of an electrode winding can be deformed to create a suitable receptacle for the elevations of a contact metal sheet with at least one bead, as described above.

### Preferred Design of the Housing Parts

Regardless of its shape (e.g., prismatic or cylindrical), the housing of an energy storage element is preferably a metal housing. It preferably comprises a cup-shaped housing part and a lid.

In a preferred embodiment, the energy storage element has at least one of the immediately following features a. and b.:
a. The cup-shaped housing part consists of aluminum, an aluminum alloy, nickel, copper, stainless steel, or nickel-plated steel.
b. The lid consists of aluminum, an aluminum alloy, nickel, copper, stainless steel, or nickel-plated steel.

The immediately preceding features a. and b. are preferred in combination.

In some embodiments, it is desirable to connect the free edge strip of one of the current collectors directly to the housing. For this purpose, the free edge strip of this current collector can be welded to the bottom of a cup-shaped housing part, for example by means of a laser. In this case, this bottom serves as a contact plate.

Conversely, in some embodiments, a contact plate may be provided to serve as a lid, i.e., as part of the housing.

In particular in the case of sodium-ion cells, it may be provided in preferred embodiments that both the cup-shaped housing part and the lid consist of aluminum or an aluminum alloy.

Suitable aluminum alloys for the cup-shaped housing part are, for example, Al alloys of the type 1235, 1050, 1060, 1070, 3003, 5052, Mg3, Mg212 (series 3000) and GM55. AlSi, AlCuTi, AlMgSi, AlSiMg, AlSiCu, AlCuTiMg, and AlMg are also suitable. The aluminum content of these alloys is preferably above 99.5%.

In some embodiments, the bottom of the cup-shaped housing part is welded in, i.e. it is manufactured separately and connected to the side wall or side walls by welding. In most cases, however, the cup-shaped housing part is manufactured by deep drawing.

### Preferred Nominal Capacity of the Energy Storage Element

The nominal capacity of the energy storage element, when designed as a cylindrical round cell, is preferably up to 10,000 mAh. With a form factor of 21×70, the energy storage element in an embodiment as a sodium-ion cell preferably has a nominal capacity in a range from 1000 mAh to 5000 mAh.

### Insulation of Internal Conductors

In preferred embodiments, the energy storage element has the immediately following features a. to g.:
a. It comprises an airtight and liquid-tight housing which has a metallic cup-shaped housing part with the bottom and a terminal circular opening, and a lid with a circular edge which closes the terminal circular opening.
b. The assembly is arranged in axial alignment in the cup-shaped housing part, with the first end face pointing towards the lid and the second end face pointing towards the bottom, where necessary being in direct contact with the bottom.
c. It comprises an annular seal made of an electrically insulating material, which surrounds the circular edge of the lid and electrically insulates the cup-shaped housing part and the lid from each other.
d. The cup-shaped housing part comprises an inner side and an outer side and, in axial succession, the bottom, a central section, and a closure section, wherein
   the central section is cylindrical and, in the central section, the winding shell of the assembly formed as a winding is in contact with the inner side of the cup-shaped housing part, and
   in the closure section, the annular seal is in press contact with the lid and the inner side of the cup-shaped housing part.
e. The central section and the closure section are separated by an indentation which circumferentially surrounds the outside of the cup-shaped housing part.
f. The contact metal sheet is connected electrically to the free edge strip of the current collector protruding from the first terminal end face by welding and to the lid, preferably also by welding.
g. The energy storage element comprises at least one insulating element made of an electrically insulating material which protects the contact metal sheet and/or the first longitudinal edge of the current collector protruding from the first terminal end face and/or a separate electrical conductor fixed to the contact metal sheet from direct contact with the inside of the cup-shaped housing part, in particular in the region of the indentation.

This measure ensures that the risk of a short circuit in the cell's internal contact area is reduced. Axial forces occurring, for example, in connection with height calibration generally no longer lead to direct contact between oppositely polarized cell components. These are prevented by the at least one insulating element.

In a first preferred further development of this preferred embodiment, the energy storage element has at least one of the immediately following features a. to c.:
a. The at least one insulating element is or comprises an insulating tape which is applied to the edge delimiting the end face and protects it from direct contact with the inner side.
b. The at least one insulating element is or comprises an annular molded part made of plastic, preferably with an L-shaped cross section, which is applied to the edge delimiting the end face and protects it from direct contact with the inner side.
c. The insulating tape or the annular molded part made of plastic has a thickness in the range from 10 μm to 200 μm.

It is preferred that the immediately preceding features a. and c. as well as b. and c. are realized in combination.

The insulating tape may be, for example, a Kapton/polyimide adhesive tape.

The annular plastic molded part, preferably with an L-shaped cross-section, can be manufactured by injection molding, for example, and can be pushed onto the edge to be protected. It can consist of Teflon or polyamide, for example.

In a second preferred further development of this preferred embodiment, the energy storage element has at least one of the immediately following features a. to c.:
a. The at least one insulating element is or comprises an annular insulating element made of plastic, which rests against the inside of the cup-shaped housing part in the region of the indentation and protects it from direct contact with the contact metal sheet.
b. The annular insulating element is a partial section of the annular seal.
c. The annular insulating element made of plastic has a thickness in the range from 20 μm to 400 μm.

It is preferred that the immediately preceding features a. and b. are implemented in combination. The features a. to c. are preferred when implemented in combination.

The annular insulating element can also be a molded part, as is the annular seal. The thickness of the insulating element is preferably in a range from 20 μm to 400 μm.

The annular insulating element may, for example, consist of Teflon, polyamide, polybutylene terephthalate or a perfluoroalkoxy polymer.

In a third preferred further development of this preferred embodiment, the energy storage element has at least one of the immediately following features a. to d.:
a. The at least one insulating element is or comprises an annular plastic part which surrounds the contact metal sheet and protects it from direct contact with the inside of the cup-shaped housing part in the region of the indentation.
b. The annular plastic part is hollow cylindrical, comprises a jacket and is bounded at the end faces by a circumferential edge.
c. The annular plastic part is hollow-cylindrical, comprises a jacket and is bounded at the end faces by a circumferential edge, one of the edges being formed as an annular collar directed outwards and resting on the contact metal sheet.
d. The annular plastic part has a thickness in a range from 20 μm to 600 μm.

It is preferred that the immediately preceding features a. and b., preferred features a. and b. and d., are realized in combination. The immediately preceding features a. and c. and d. are preferred in combination.

The annular plastic part may also be a molded part. The thickness of the plastic part is preferably in a range from 20 μm to 600 μm.

The plastic part can, for example, be made of Teflon, polyamide, polybutylene terephthalate or a perfluoroalkoxy polymer.

In a fourth preferred further development of this preferred embodiment, the energy storage element has at least one of the immediately following features a. and b.:
a. The at least one insulating element is or comprises an electrically insulating plastic coating which surrounds an edge of the contact metal sheet and protects it from direct contact with the inside of the cup-shaped housing part, in particular in the region of the indentation.
b. The electrically insulating coating is formed by overmolding the edge of the contact metal sheet.

It is preferred that the immediately preceding features a. and b. are implemented in combination.

In principle, all thermoplastics with electrically insulating properties are suitable for overmolding the edge of the contact metal sheet. Polyamide is suitable, for example.

The present disclosure also includes combinations of the four preferred developments described. The energy storage element is preferred when it has a combination of two or more of the four immediately following features a. to d.:
a. The at least one insulating element comprises an insulating tape or annular molded part made of plastic, which is applied to the edge delimiting the end face and protects it from direct contact with the inner side, i.e., an insulating tape or an annular molded part according to the first preferred development, and/or
b. the at least one insulating element comprises an annular insulating element which bears against the inner side of the cup-shaped housing part in the region of the indentation and protects it from direct contact with the contact metal sheet, i.e. an annular insulating element according to the second preferred development, and/or
c. the at least one insulating element comprises an annular plastic part which surrounds the contact metal sheet and protects it from direct contact with the inside of the cup-shaped housing part in the region of the indentation, i.e. an annular plastic part according to the third preferred development, and/or
d. the at least one insulating element is or comprises an electrically insulating plastic coating which surrounds an edge of the contact metal sheet and protects it from direct contact with the inside of the cup-shaped housing part, in particular in the region of the indentation, i.e. a plastic coating according to the fourth preferred development.

It is preferred that the energy storage element is characterized by at least one of the following features a. or b.:
a. The cup-shaped housing part has an identical maximum outer diameter in the central section and the closure section.
b. In the region of the indentation, the outer diameter of the cup-shaped housing part is reduced by 4 to 20 times the wall thickness of the cup-shaped housing part in this region.

It is preferable that the immediately preceding features a. and b. are implemented in combination.

### Cell Closure by Casting Compound

In a preferred embodiment, the energy storage element has the immediately following features:
a. It comprises an airtight and liquid-tight housing which has a metallic, cup-shaped housing part with a bottom and a terminal opening and a lid which closes the terminal opening.
b. The lid comprises a metallic lid plate and a connection pole which is guided through an aperture in the lid plate and is electrically insulated from the lid plate.
c. The assembly is arranged in the cup-shaped housing part, with one side facing the lid and a second side facing the bottom, optionally being in direct contact with the bottom.
d. The cathode and the anode are formed and/or arranged within the assembly in such a way that the free edge strip of the cathode current collector protrudes from the side of the assembly and the free edge strip of the anode current collector protrudes from one side of the assembly, and
e. The contact metal sheet rests directly on the free edge strip of one of the current collectors protruding from one of the sides of the assembly and is connected to the latter by welding.
f. The contact metal sheet is either electrically connected to the connecting pole passing through the aperture in the lid plate, preferably directly welded to the connecting pole, or the connecting pole is part of the contact metal sheet.
g. The connection pole is electrically insulated from the lid plate by a hardened casting compound made of an electrically insulating plastic material.

A lid of this design ensures that there is basically no dead volume between the assembly and the metal lid plate. Any space between the contact metal sheet, the connection pole, and the lid plate can be filled with the casting compound. A lid with the above features can be constructed very compactly.

Furthermore, an energy storage element with the immediately preceding features a. to g. has the advantage that it is possible to make electrical contact with both the anode and the cathode via the lid.

In a preferred further development of this embodiment, the energy storage element has the immediately following feature a.:
a. The edge strip of the cathode current collector or the anode current collector not being in direct contact with the contact metal sheet is electrically connected to the housing bottom, preferably welded directly to the housing bottom.

In many cases, it is preferred in this embodiment that the cup-shaped housing part is positively polarized and the connection pole is a negative connection pole. In these cases, the energy storage element has the immediately following feature a., optionally in combination with at least one other of the following features b. and c.:
a. The cup-shaped housing part is electrically connected to the cathode.
b. The cup-shaped housing part consists of aluminum or an aluminum alloy.
c. The lid plate consists of aluminum or an aluminum alloy.

The immediately preceding features a. to c. are preferred in combination.

In this embodiment, the housing of the energy storage element consists mainly of aluminum or an aluminum alloy. This has various advantages. The formation of local elements when the outside of the cell comes into contact with moisture is prevented. The housing itself can basically serve as a positive connection pole on all sides. However, it is preferred that the cell is contacted exclusively via the lid, where the negative connection pole is also located. For this purpose, a current conductor can be welded directly to the lid plate or alternatively fixed to the separate connection pole, for example by welding.

In other cases, it may be preferable for the cup-shaped housing part to be negatively polarized and the connection pole to be a positive connection pole. In these cases, the energy storage element has the immediately following feature a., optionally in combination with at least one other of the following features b. and c.:
a. The cup-shaped housing part is electrically connected to the anode.
b. The cup-shaped housing part consists of aluminum or an aluminum alloy.
c. The lid plate consists of aluminum or an aluminum alloy.

The immediately preceding features a. to c. are preferred in combination.

In preferred embodiments, the energy storage element has at least one of the immediately following features a. and b.:
a. Between the lid plate and the contact metal sheet there is an annular gap which is filled with the casting compound.
b. The annular gap is bounded radially outward by an O-ring-shaped insulating disc made of an electrically insulating plastic material.

In further preferred embodiments, the energy storage element has at least one of the immediately following features a. to c.:
a. The contact metal sheet consists of aluminum or an aluminum alloy.
b. The connection pole consists of aluminum or an aluminum alloy.
c. The contact metal sheet, the connecting pole and the cathode current collector consist of the same material.

In embodiments in which the connecting pole is part of the contact metal sheet, the contact metal sheet serves simultaneously as a conductor for the current from the anode or cathode current collector and as a pole. Accordingly, there is no need for a separate electrical conductor as known from the prior art, which is generally arranged between a lid or a lid assembly and a contact plate as described in WO 2017/215900 A1.

In this embodiment, the contact metal sheet preferably comprises a flat region which rests directly on the free edge strip of one of the current collectors protruding from one of the sides of the assembly and is connected to the latter by welding, and a projection pointing away from this side. The projection serves as the connection pole and is preferably guided through the aperture in the lid plate.

The contact metal sheet has at least one of the immediately following features a. and b.:
a. The projection of the metal part pointing away from the first terminal end face is shaped as a cup.
b. The contact metal sheet including the projection is a one piece part.

It is preferred that the immediately preceding features a. and b. are realized in combination.

The contact metal sheet with the projection shaped as a cup can be produced, for example, in a deep-drawing process, in which case it is preferably formed in one piece. However, it can also be produced, for example, by a forming or a machining manufacturing step from a metallic workpiece or by means of 3D printing.

In a preferred embodiment, the energy storage element is characterized by the following features a. and b.:
a. The housing bottom of the cup-shaped housing part has a primary safety device against internal overpressure in the form of an aperture which is closed by a metallic membrane.
b. The housing bottom of the cup-shaped housing part has a secondary safety device against internal overpressure in the form of at least one groove on its inner side or its outer side.

The primary safety device has the function of bringing about controlled pressure equalization when an impermissible overpressure above a defined threshold value occurs. In this case, the membrane is burst open or blown off by the pressure, and gas formed inside the housing can escape through the aperture in the housing bottom.

The secondary safety device is intended for cases where pressure equalization via the primary safety device does not occur quickly enough. In this case, the housing bottom may tear open along the groove, which is nothing more than a weakening of the structure of the housing bottom, due to the overpressure, so that an outlet opening with a comparatively large cross-section is created through which gas formed inside the housing can escape.

Such safety solutions are already known per se. The pressure at which the safety devices are triggered can be precisely adjusted by suitable design of the groove and the membrane.

Since the safety functions mentioned are not integrated in the lid, as is the case with many conventional cells, but instead in the housing bottom, it is possible to construct the lid in an extremely compact manner. It is also not absolutely necessary to pre-assemble the lid. Instead, the lid can be manufactured during housing assembly.

In preferred embodiments, the energy storage element has at least one of the immediately following features a. to e.:
a. The lid plate is welded into the terminal opening of the cup-shaped housing part.
b. The contact metal sheet is connected to the contact metal sheet of the anode current collector or to the free edge strip of the cathode current collector by welding.
c. The free edge strip not being in direct contact with the contact metal sheet rests directly on the housing bottom.
d. The free edge strip not being in direct contact with the contact metal sheet is connected to the housing bottom by welding.
e. The at least one groove is located on the inside of the housing bottom.

The immediately preceding features a. to d. are preferably implemented in combination, and the immediately preceding features a. to e. are preferred implemented in combination.

In a further preferred embodiment, the energy storage element is characterized by the following feature a.
a. The metallic membrane is fixed to the bottom of the cup-shaped housing part by welding.

The bottom of the cup-shaped housing part may have a flat depression into which the membrane is inserted so that it does not protrude. It is preferably connected to the bottom by a circular weld seam which is led around the aperture in the bottom.

The thickness of the membrane can be adjusted to the pressure at which the safety device is to be triggered.

In preferred embodiments, the energy storage element has at least one of the immediately following features a. to g.:
a. The housing bottom has at least one bead which appears on its outer side as an elongated depression and on its inner side as an elongated elevation, wherein the edge strip of the cathode current collector or of the anode current collector which is not in direct contact with the contact metal sheet rests on the inner side.
b. The edge strip of the cathode current collector or the anode current collector not being in direct contact with the contact metal sheet is electrically connected to the housing bottom, preferably welded directly to the housing bottom.
c. The housing bottom is welded to the free edge strip of the anode current collector or the free edge strip of the cathode current collector in the region of the bead.
d. The aperture is positioned in the center of the housing bottom.
e. The at least one bead comprises several linear beads, in particular three beads, which are arranged in a star-shaped arrangement around the aperture.
f. The at least one bead comprises several linear partial sections which are arranged in a star-shaped arrangement around the aperture.
g. The at least one bead comprises a partial section running around the aperture, which connects the star-shaped linear partial sections to one another.

The immediately preceding features a. and b., c. and d., and c. and e. and f. are preferably realized in combination. The immediately preceding features a. to g. are preferred realized in combination.

As a result of the welding in the region of the bead, one or more weld seams are preferably found there. The star-shaped beads and the star-shaped linear partial sections of the groove preferably form an angle of 120° with each other.

In some embodiments, it has proven advantageous to subject the free edge strip of the current collector, which rests on the inside of the housing bottom, to a pretreatment in order to improve the contact between the housing bottom and the current collector. In particular, at least one depression corresponding to the at least one bead can be folded into the edge.

The edge of the current collector may also have been subjected to a directed forming pretreatment. For example, it may be bent in a defined direction.

### Battery

Energy storage elements, in particular based on sodium-ion technology, not only offer high power densities, they are also fast-charging, perform well at low temperatures and offer excellent cycle stability. In addition, sodium, for example, is available in practically unlimited quantities.

For all these reasons, energy storage elements, in particular those based on sodium-ion technology, are ideally suited for use in starter batteries that can replace lead-acid batteries, for example in motor vehicles.

The present disclosure accordingly comprises:
any battery comprising two or more energy storage elements, in particular those based on sodium-ion technology, connected in series and/or in parallel.

The battery particularly comprises a plurality of energy storage elements, which are connected to one another in such a way that the battery supplies a voltage of 12 volts or 24 volts.

Typically, an energy storage element based on sodium-ion technology supplies a nominal voltage in a range from 1.5 volts to 4.8 volts, preferably from 2.4 volts to 4 volts. Accordingly, a battery with a nominal voltage of 12 V preferably comprises 3 to 5 energy storage elements connected in series.

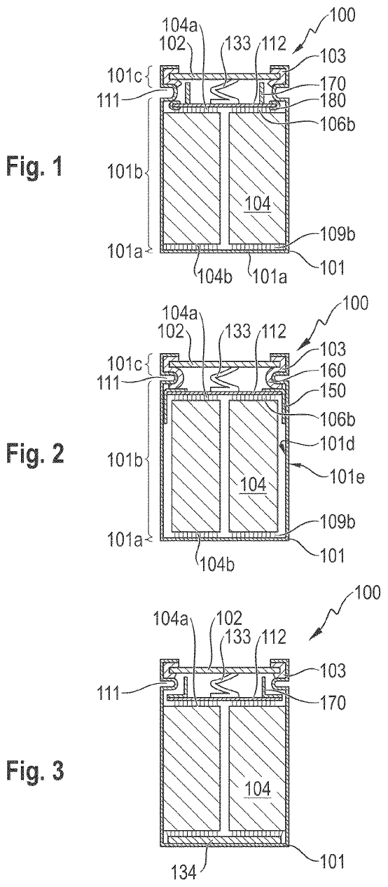

Further features and advantages are apparent from the claims and from the following description of preferred examples in conjunction with the drawings. The individual features may be realized individually or in combination with one another.
FIG. 1 shows an energy storage element 100 according to the invention with a housing sealed against air and liquids, which comprises a metallic, cup-shaped housing part 101 with a terminal circular opening and a lid 102 with a circular edge 102a, which closes the circular opening. The energy storage element further comprises an annular seal 103 made of an electrically insulating material, which surrounds the circular edge 102a of the lid 102 and electrically insulates the cup-shaped housing part 101 and the lid 102 from each other.

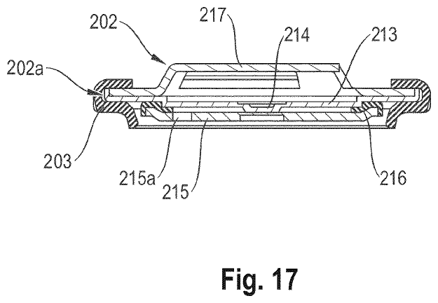

The lid is shown only in the form of a disc. However, multi-part lid assemblies are regularly used as lids, for example those shown in FIG. 17.

The cup-shaped housing part 101 comprises, in axial sequence, a bottom 101a, a central section 101b and a closure section 101c, wherein the central section 101b is cylindrical and, in the central section 101b, the winding shell 104c of the assembly 104 formed as a winding is in contact with the inner side 101d of the cup-shaped housing part 101, and in the closure section 101c the annular seal 103 is in press contact with the lid 102 and the inner side of the cup-shaped housing part 101. The central section 101b and the closure section 101c are separated by an indentation 111 which circumferentially surrounds the outer side 101e of the cup-shaped housing part 101.

The assembly 104 in the form of a cylindrical winding with the sequence anode/separator/cathode is not shown in detail here. Only the longitudinal edge 106a of the anode current collector 106 protruding from the end face 104a of the assembly 104 and the longitudinal edge 109a of the cathode current collector 109 protruding from the end face 104b of the assembly 104 are visible. The longitudinal edge 109a is welded directly to the housing bottom 101a, preferably over its entire length. The longitudinal edge 106a is welded directly to the contact metal sheet 112, preferably over its entire length. The contact metal sheet 112 is in turn connected to the lid 102 via the electrical conductor 133.

The energy storage element 100 preferably has a height in the range from 60 mm to 100 mm, its diameter preferably lies in the range from 20 mm to 50 mm. The cup-shaped housing part 101 typically has a wall thickness in the central section 101b in the range from 0.1 mm to 0.3 mm.

The energy storage element comprises, as an insulating element, an electrically insulating plastic coating 180 which surrounds the edge of the contact metal sheet 112 and protects it from direct contact with the inner side 101d of the cup-shaped housing part 101, in particular in the region of the indentation 111. The electrically insulating coating 180 is formed by overmolding the edge of the contact metal sheet 112. Furthermore, the energy storage element 100 comprises as an insulating element an annular plastic part 170 which surrounds the separate electrical conductor 133 fixed to the contact metal sheet and protects it from direct contact with the inner side 101d of the cup-shaped housing part 101 in the region of the indentation 111.

As a result, the energy storage element 100 is also excellently protected against short circuits in the event of deformation of the housing as a result of an external mechanical force.

FIG. 2 shows an energy storage element 100 with a housing sealed airtight and liquid-tight, which comprises a metallic, cup-shaped housing part 101 with a terminal circular opening and a lid 102 with a circular edge 102a, which closes the circular opening. The energy storage element further comprises an annular seal 103 made of an electrically insulating material, which surrounds the circular edge 102a of the lid 102 and electrically insulates the cup-shaped housing part 101 and the lid 102 from each other.

The lid is shown only in the form of a disc. However, multi-part lid assemblies are regularly used as lids, for example those shown in FIG. 17.

The cup-shaped housing part 101 comprises, in axial succession, a bottom 101a, a central section 101b and a closure section 101c, wherein the central section 101b is cylindrical and in the central section 101b the winding shell 104c of the assembly 104 formed as a winding is in contact with the inner side 101d of the cup-shaped housing part 101 (Note: For clarity only, the assembly 104 is shown here spaced apart from the inner side 101d, but in fact it presses against it, as shown, for example, in FIG. 1), and in the closure section 101c, the annular seal 103 is in press contact with the lid 102 and the inner side of the cup-shaped housing part 101. The central section 101b and the closure section 101c are separated by an indentation 111 which circumferentially surrounds the outer side 101e of the cup-shaped housing part 101.

The assembly 104 in the form of a cylindrical winding with the sequence anode/separator/cathode is not shown in detail here. Only the longitudinal edge 106a of the anode current collector 106, which protrudes from the end face 104a of the assembly 104, and the longitudinal edge 109a of the cathode current collector 109, which protrudes from the end face 104b of the assembly 104, are visible. The longitudinal edge 109a is welded directly to the housing bottom 101a, preferably over its entire length. The longitudinal edge 106a is welded directly to the contact metal sheet 112, preferably over its entire length. The contact metal sheet 112 is in turn connected to the lid 102 via the electrical conductor 133.

The energy storage element 100 preferably has a height in the range from 60 mm to 100 mm, its diameter preferably lies in the range from 20 mm to 50 mm. The cup-shaped housing part 101 typically has a wall thickness in the central section 101b in the range from 0.1 mm to 0.3 mm.

The energy storage element comprises as an insulating element an annular molded part made of plastic 150 with an L-shaped cross section, which is applied to the edge which bounds the end face 104a and protects it from direct contact with the inner side 101d of the cup-shaped housing part 101. Furthermore, the energy storage element comprises an annular insulating element 160 made of plastic, which rests against the inner side 101d of the cup-shaped housing part 101 in the region of the indentation 111 and protects it from direct contact with the electrical conductor 133. This may also be a partial section of the annular seal 103, which may be sufficiently high to also cover the indentation 111 from the inside.

As a result, the energy storage element 100 is also excellently protected against short circuits in the event of deformation of the housing as a result of an external mechanical force.

Instead of the annular plastic molded part 150 with an L-shaped cross section, the edge which delimits the end face 104a can also be covered with an insulating tape, for example a Kapton tape 150. Ideally, this can be applied to the edge when the winding is formed and protects the edge just as efficiently from direct contact with the inner side 101d.

FIG. 3 shows an energy storage element 100 with a housing sealed airtight and liquid-tight, which comprises a metallic, cup-shaped housing part 101 with a terminal circular opening and a lid 102 with a circular edge 102a, which closes the circular opening. The energy storage element further comprises an annular seal 103 made of an electrically insulating material, which surrounds the circular edge 102a of the lid 102 and electrically insulates the cup-shaped housing part 101 and the lid 102 from each other.

The lid is shown only in the form of a disc. However, multi-part lid assemblies are regularly used as lids, for example those shown in FIG. 17.

The cup-shaped housing part 101 comprises, in axial succession, a bottom 101a, a central section 101b and a closure section 101c, wherein the central section 101b is cylindrical and, in the central section 101b, the winding shell 104c of the assembly 104, which is designed as a winding, is in contact with the inner side 101d of the cup-shaped housing part 101 and, in the closure section 101c, the annular seal 103 is in press contact with the lid 102 and the inner side of the cup-shaped housing part 101. The central section 101b and the closure section 101c are separated by an indentation 111, which circumferentially surrounds the outer side 101e of the cup-shaped housing part 101.

The assembly 104 in the form of a cylindrical winding with the sequence anode/separator/cathode is not shown in detail here. Only the longitudinal edge 106a of the anode current collector 106, which protrudes from the end face 104a of the assembly 104, and the longitudinal edge 109a of the cathode current collector 109, which protrudes from the end face 104b of the assembly 104, are visible. The longitudinal edge 109a is welded directly to the contact metal sheet 134, preferably over its entire length. The contact metal sheet 134 is in turn connected to the bottom 101a by welding. The longitudinal edge 106a is welded directly to the contact metal sheet 112, preferably over its entire length. The contact metal sheet 112 is in turn connected to the lid 102 via the electrical conductor 133.

The energy storage element 100 preferably has a height in the range from 60 mm to 100 mm, its diameter preferably lies in the range from 20 mm to 50 mm. The cup-shaped housing part 101 typically has a wall thickness in the range from 0.1 mm to 0.3 mm in the central section 101b.

The energy storage element comprises, as an insulating element, an annular plastic part 170 which laterally surrounds the electrical conductor 133 and protects it from direct contact with the inner side 101d of the cup-shaped housing part 101 in the region of the indentation 111. The annular plastic part 170 is hollow cylindrical in design and comprises a jacket 171 standing perpendicular to the contact metal sheet 112. One of its edges is formed as an outwardly directed annular collar 171 and rests on the contact metal sheet 112.

As a result, the energy storage element 100 is also excellently protected against short circuits in the event of deformation of the housing due to an external mechanical force.

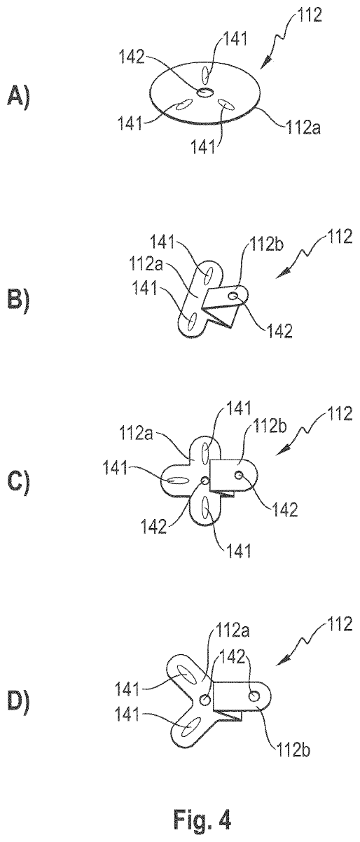

FIG. 4 shows several embodiments of a contact metal sheet 112 which is suitable for contacting the first longitudinal edge 106a of the current collector 106 protruding from the first terminal end face 104a of an energy storage element 100.

Embodiment A shows a circular and essentially flat metal disc with a circumferential edge 102a as the contact metal sheet 112. This is characterized by a central hole 142 and three offset beads 141. Such a component can be used in the energy storage elements according to FIGS. 1 to 3 for electrical contacting of the edge 106a of the anode current collector 106. However, it is also suitable for use as a contact metal plate 134 in the energy storage element according to FIG. 3. When using such a metal disc for contacting the longitudinal edge 106a, the separate conductor 133 shown in FIGS. 1 to 3 is generally required to bridge the distance to the contact metal plate 102.

This is not the case with embodiment B. Here, the contact metal sheet 112 comprises a first section 112a, which can rest flat on the first longitudinal edge of the current collector protruding from the first terminal end face 104a and which then extends parallel to the end face 104a. However, it also comprises a second section 112b, which is connected at an angle to the first section 112a and via which the first section 112a is electrically connected to the lid 102. When using such a contact metal sheet, no separate conductor 133 is required. The contact metal sheet 112 is further characterized by a hole 142 and two beads 141. The contact metal sheet is preferably welded to the longitudinal edge of the respective current collector in these beads.

The embodiments C and D differ from embodiment B in that the section 112a comprises three or four strips extending in different directions. Each of the strips has a bead 141. In addition, the sheet metal parts each have two holes 142.

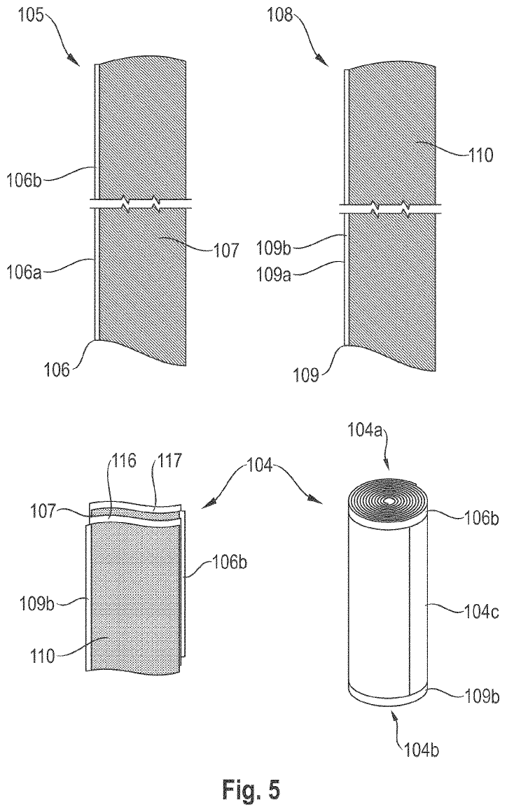

The structure of the assembly 104 is illustrated in FIG. 5. The assembly 104 comprises the ribbon-shaped anode 105 with the ribbon-shaped anode current collector 106, which has a first longitudinal edge 106a and a second longitudinal edge parallel thereto. The anode current collector 106 is a foil made of aluminum. It comprises a ribbon-shaped main region, which is loaded with a layer of negative electrode material 107, and a free edge strip 106b, which extends along its first longitudinal edge 106a and is not loaded with the electrode material 107. Furthermore, the assembly 104 comprises the ribbon-shaped cathode 108 with the ribbon-shaped cathode current collector 109, which has a first longitudinal edge 109a and a second longitudinal edge parallel thereto. The cathode current collector 109 is also an aluminum foil. It comprises a ribbon-shaped main region which is loaded with a layer of positive electrode material 110, and a free edge strip 109b which extends along its first longitudinal edge 109a and which is not loaded with the electrode material 110. Both electrodes are shown individually in an unwound state.

The anode 105 and the cathode 108 are arranged offset from each other within the assembly 104 so that the first longitudinal edge 106a of the anode current collector 106 protrudes from the first terminal end face 104a and the first longitudinal edge 109a of the cathode current collector 109 protrudes from the second terminal end face 104b of the assembly 104. The offset arrangement is shown in the figure at the bottom left. The two ribbon-shaped separators 116 and 117 are also shown there, which separate the electrodes 105 and 108 from each other in the winding.

The figure at the bottom right shows the assembly 104 in wound form as it can be used in an energy storage element according to one of FIGS. 1 to 4. The electrode edges 106a and 109a protruding from the end faces 104a and 104b are clearly visible. The winding shell 104c is formed by a plastic film.

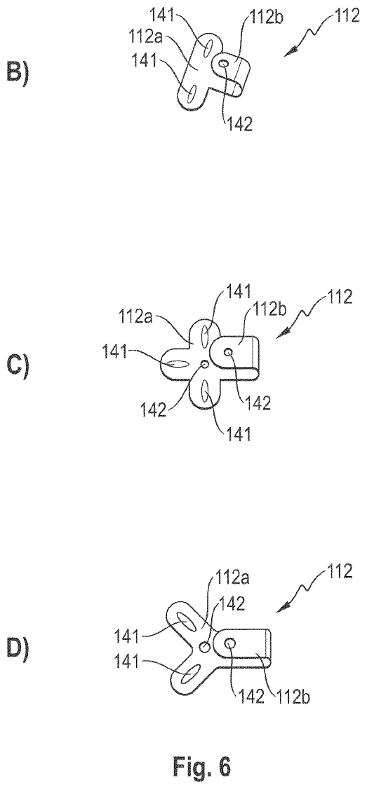

FIG. 6 shows further embodiments of the contact metal sheet 112, which is suitable for contacting the first longitudinal edge 106a of the current collector 106 protruding from the first terminal end face 104a of an energy storage element 100.

The embodiments B-D shown here differ from the contact metal sheets shown in embodiments B-D of FIG. 4 essentially only in that section 112b is not folded into a Z-shape but is bent into a U-shape. Such contact metal sheets can replace the contact metal sheet 112 and the electrical conductor 133 in the energy storage elements according to FIGS. 1 to 3.

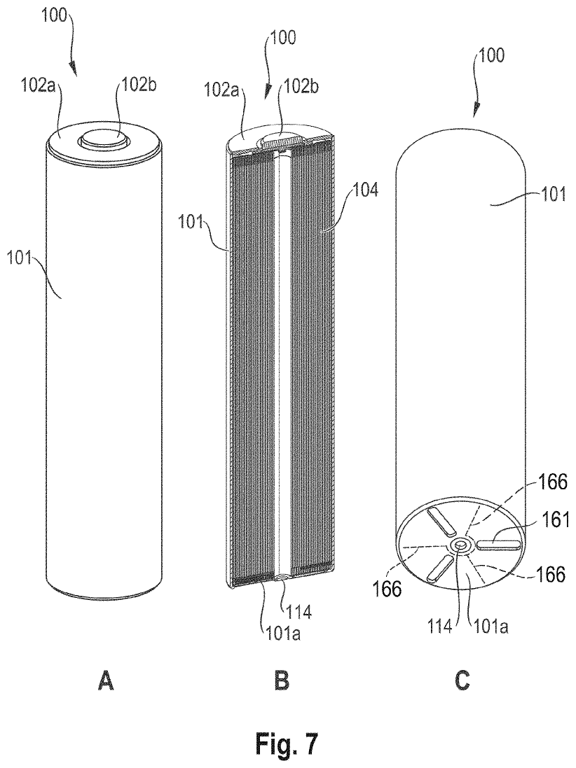

FIG. 7A-C shows a preferred embodiment of an energy storage cell in a view from above at an angle (FIG. 7A), in a longitudinal section (FIG. 7B) and in a view from below at an angle (FIG. 7C). The energy storage cell 100 has the shape of a cylindrical round cell. The housing of the energy storage cell 100 is formed by a cup-shaped housing part 101 and a lid. The lid comprises a lid plate 102a, which has the shape of a perforated plate, and a connection pole 102b in the center of the lid component.

As can be seen in the sectional view in FIG. 7B, the wound assembly 104 is located inside the energy storage cell 100 and is formed from the wound electrode tapes with separator tapes between them.

FIG. 7C shows the bottom side of the energy storage cell 100, which is formed by the housing bottom 101a. Three welded embossings in the form of beads 161 are arranged in a star shape in the housing bottom 101a, which appear as depressions on the outside and as elongated elevations on the inside. The longitudinal edge of the respective current collector rests on these beads 161 on the inside, and in the region of these beads, the current collector is preferably welded directly to the housing bottom.

Aluminum is the preferred material for the housing bottom 101a and the entire cup-shaped housing part 101.

In the present example, two safety functions are integrated into the housing bottom 101a. On the one hand, there is an aperture in the center of the housing bottom 101a, which is closed by a metallic membrane 114. In the event of excess pressure due to a malfunction of the cell, this membrane 114 brings about pressure equalization by either bursting or being blown off by the pressure. In this way, any gas that may form inside the cell can escape through the aperture in the housing bottom 101a (primary safety device).

In addition, a further safety function is provided in the housing bottom 101a, which is realized by three star-shaped grooves 166. These grooves 166 weaken the structure of the housing bottom 101a and thus form predetermined breaking points in the event of overpressure occurring inside the cell (secondary safety device). In this example, the grooves 166 are located on the inner side of the housing bottom 101a and are therefore shown as dashed lines in FIG. 7C. The grooves 166 can, for example, be formed as three scratch lines. The star-shaped arrangement of the scratch lines is further formed by a partial circular connection of the scratch lines or the grooves 166. At a correspondingly high overpressure, the housing bottom 101a tears open along the grooves 166 and the partial circular connection of these grooves, so that an outlet opening with a comparatively large cross-section is created, through which gas formed inside the housing can escape quickly if necessary.

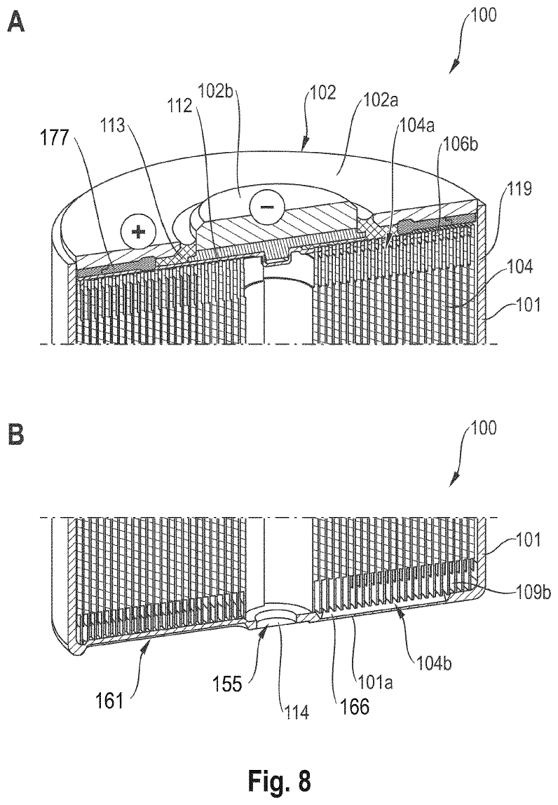

FIG. 8A,B shows an enlarged view of the end face regions of the embodiment of the energy storage cell 100 according to FIG. 7. FIG. 8A shows details of the end face with the lid 102. The lid 102 comprises the lid plate 102a with a central aperture and with the connection pole 102b arranged in the center of the lid plate 102a. In this example, the connection pole 102b can form the negative pole and the surrounding lid plate 102a can form the positive pole of the energy storage cell 100.

Below the connection pole 102b is the contact metal sheet 112, which rests on the free edge strip 106b of the spirally arranged anode current collector of the negative electrode and is welded thereto. The contact metal sheet 112 is electrically connected to the connection pole 102b, which is formed from two metallic components, in particular also by welding. The lid plate 102a is electrically insulated from the contact metal sheet 112 by an O-ring-shaped insulating disc 177. Furthermore, an electrically insulating molding compound 113 is located in a gap between the connection pole 102b and the lid plate 102a.

FIG. 8B shows details of the opposite end face of the energy storage cell 100. The free edge strip 109b of the cathode current collector is electrically connected, in particular welded, to the housing bottom 101a on this end face of the energy storage cell 100. The electrical contact to the metallic lid plate 102a on the opposite end face is established via the jacket of the cup-shaped housing part 101, so that the positive potential of the cell can also be tapped on the upper end face of the energy storage cell 100.

The preferred safety functions of the cell against overpressure can be seen on the lower end face of the energy storage cell 100 shown in FIG. 8B. The primary safety device is formed by the metallic membrane 114, which closes a central circular aperture 155 in the housing bottom 101a. The secondary safety device is formed by the grooves 166, one of the three star-shaped grooves 166 being visible in section in this illustration. The grooves 166 located on the inside of the housing bottom 101a represent a defined weakening structure of the housing bottom, so that when relatively high overpressure builds up inside the cell, these structures open and gas can escape.

The preferred design of an energy storage cell 100, illustrated in FIG. 8, allows for a reduced number of parts in the upper region of the energy storage cell (FIG. 8A), wherein the negative and positive terminals of the cell are arranged in this upper region. In particular, this design eliminates the need for additional conductors due to the one-piece construction of the connection pole 102b.

The direct contacting of the longitudinal edge of one of the electrode strips on the side of the housing bottom (partial FIG. 8B) also contributes to the particularly compact design of the cell, so that no dead volumes are required for the various functions of the cell.

The direct contacting of the longitudinal edges of the electrode strips also achieves improved heat dissipation and a reduction in internal resistance.

In addition, the design of this cell generally also allows longer windings to be formed, resulting in a higher energy density of the resulting energy storage cell.

The upper end face of the energy storage cell 100 is designed to be as compact as possible in this configuration. Any gases that may arise inside the cell and lead to a pressure increase are inevitably conducted to the lower region of the cell, where the safety functions for pressure equalization are located. Overall, such a cell therefore has a very good level of safety.

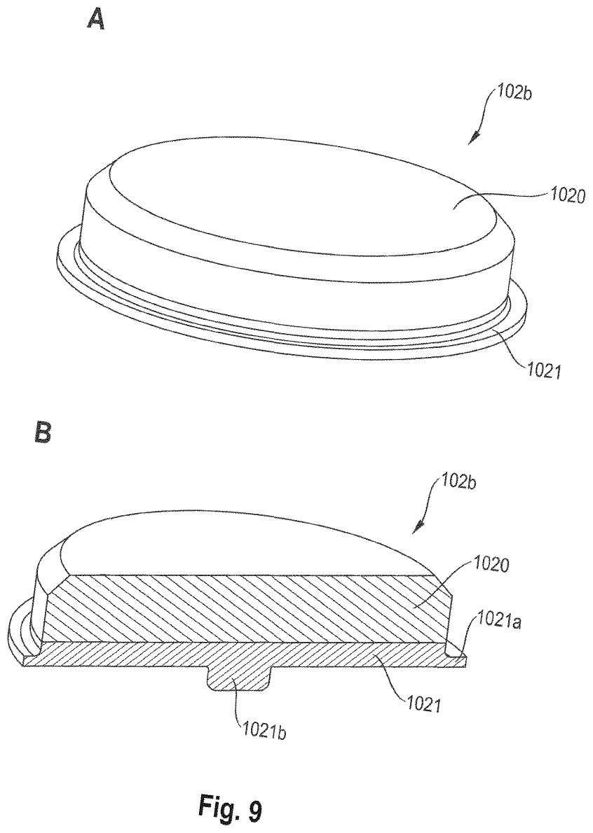

FIG. 9A,B shows a detailed view of the connection pole 102b from FIGS. 7 and 8 in an oblique view from above (FIG. 9A) and in a sectional view (FIG. 9B). The connection pole 102b can be composed of two metallic components. The upper region (pole upper part) 1020 does not necessarily have to be made of the same metal as the lower region (pole lower part) 1021. The upper region 1020 has a bevelled, circumferential upper edge. As can be seen in the sectional view according to FIG. 4B, the lower region 1021 has an outer circumferential weld shoulder 1021a and a central pin 1021b projecting downwards. The pin 1021b conveniently engages in a correspondingly provided depression in the center of the contact metal sheet 112 and thus ensures a good fit of the connection pole 102b.

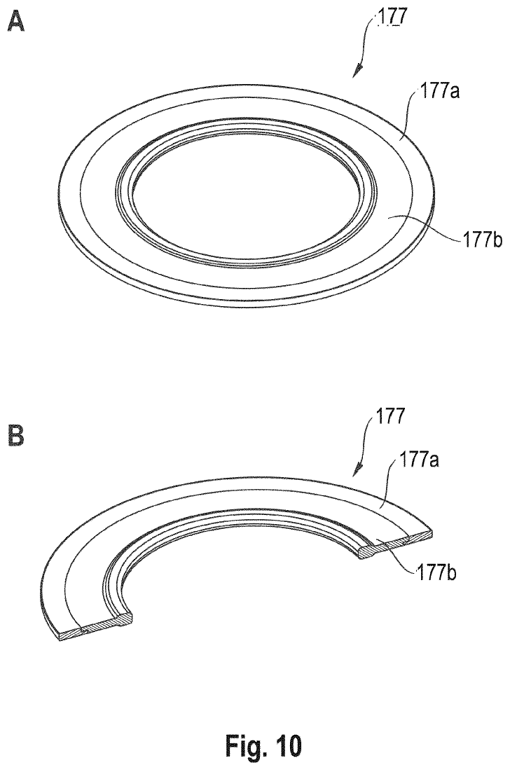

FIG. 10A,B shows the O-ring-shaped insulating disc 177 in a complete view from above at an angle (FIG. 10A) and in a sectional view (FIG. 10B). The insulating disc 177 has the function of electrically insulating the preferably positively polarized lid plate 102a from the components of the energy storage cell 100 with reverse polarity. In addition, the insulating disc 177 also provides a liquid-tight and airtight seal for the housing.

In the preferred example of the insulating disc 177 shown here, the insulating disc is made of two different materials. The outer region 177a of the insulating disc 177 is preferably made of a particularly strong plastic material, for example PBT (polybutylene terephthalate). The inner region 177b is preferably made of a slightly more flexible and, above all, particularly heat-resistant plastic, for example PET (polyethylene terephthalate). The outer region 177a thus ensures particular mechanical stability. The inner region 177b provides flexibility and is particularly resistant to the hot casting compound 13 during assembly of the energy storage cell.

The inner circumference of the O-ring-shaped insulating disc 177 has the particular advantage of a circumferential thickening, which further supports the stability of the components in the end face region of the mounted energy storage cell.

When the energy storage cell is assembled, inserting the insulating disc 177 into the cover area of the cell first provides a temporary seal for the cell until the subsequently introduced sealing compound 113 has hardened to completely seal the cell. Furthermore, the special shape of the insulating disc 177 allows axial support of the wound assembly 104, for example during testing of the cell. If the cell is deformed laterally, the shape of the insulating disc 177 also provides space for any deformation of the contact metal sheet 112. Finally, the shape of the insulating disc 177 makes it possible to reduce the volume of the casting compound 113 and the amount of any air bubbles trapped during casting when the energy storage cell is assembled.

As a possible alternative to such an insulating disc, an insulating sealing bead, comparable to a silicone bead, can be applied. This also ensures a tight seal. However, the insulating disc 177, particularly in the embodiment illustrated here, offers the various advantages mentioned above.

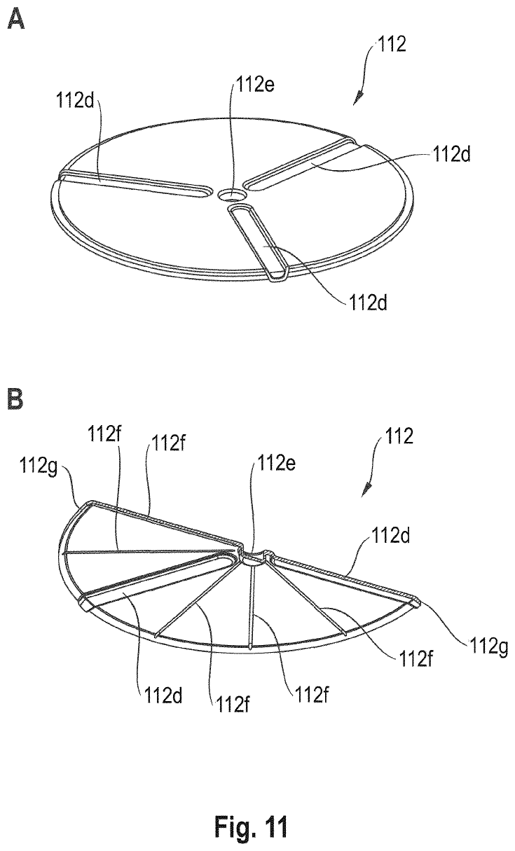

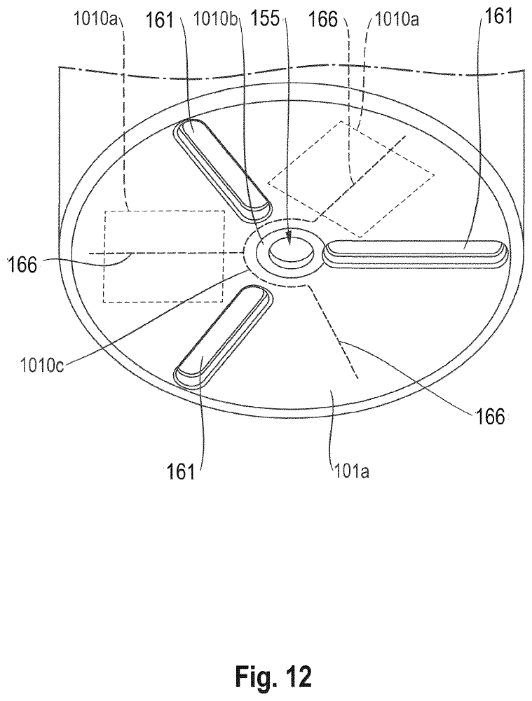

FIG. 11A, B shows a preferred embodiment of the contact metal sheet 112, which is provided for contacting the free edge of the current collector of the respective electrode in the upper region of the energy storage cell. FIG. 11A shows a top view of the disc-shaped contact metal sheet 112. FIG. 11B shows a section through the contact metal sheet 112 in a view from below, i.e., on the side of the contact metal sheet facing the assembly 104 inside the energy storage cell.

Similar to the beads 161 of the housing bottom 101a, the contact metal sheet 112 also has three star-shaped beads 112d, which appear as depressions on the outside (FIG. 11A) and as elongated elevations on the inside (FIG. 11B). The beads 112d can be embossed, for example, and have a depth of 0.25 mm, for example. When the cell is assembled, the beads 112d are in contact with the respective longitudinal edge of an electrode strip of the assembly to be contacted there. The contact metal sheet 112 is preferably welded to the respective longitudinal edge of the electrode strip via the beads 112d.

In the center of the contact metal sheet 112 there is a depression 112e. The depression 112e serves to receive the connecting pole 102b, whereby the central pin 1021b of the connecting pole 102b engages in the depression 112e. In this way, the connecting pole 102b can be easily positioned and fixed on the contact metal sheet 112, so that the connecting pole 102b can be welded on without any problems.

Furthermore, in the preferred embodiment of the contact metal sheet 112 shown here, further star-shaped narrow depressions 112f are provided, which are located on the inwardly facing side of the contact metal sheet 112. In this example, a total of nine of these depressions 112f are provided as narrow channels arranged in a star shape. The grooves may, for example, have a depth of 0.1 mm. The depressions 112f serve to improve the distribution of the electrolyte within the cell.

Furthermore, in this preferred embodiment, the contact metal sheet 112 has an embossed circumferential edge 112g, which is arranged as a predetermined bending point, in particular with the burr facing downwards. This predetermined bending point facilitates the assembly of the housing of the energy storage cell.

In preferred embodiments, the contact metal sheet 112 is made of aluminum, for example of an aluminum sheet with a material thickness of 0.3 mm.

FIG. 12 shows a detailed view of the housing bottom 101a of the energy storage cell with the star-shaped, inwardly projecting beads 161, which are formed in particular as weld embossings for contacting the wound assembly. The star-shaped arrangement with three beads 161 is particularly advantageous for mounting the cell due to its rotational symmetry.

The central aperture 155 in the housing bottom 101a is covered by a metallic membrane 114 and serves as a primary safety device for the cell in the event of excess pressure. In particular, it is intended that the aperture 155 is first used during the manufacture of the cell to fill the cell with electrolyte before the aperture 155 is closed with the metallic membrane 114.

For a precise receptable of the metallic membrane 114 for closing the central aperture 155, a circumferential depression 1010b is preferably provided, which surrounds the central aperture 155.

Furthermore, in this embodiment, three star-shaped weakening structures are provided in the form of grooves 166 open toward the inside, which are connected to one another by a semicircular connecting line 1010c. These weakening structures 166 and 1010c serve as a secondary safeguard against internal overpressure. As an alternative to attaching the weakening structures from the inside to the housing bottom, such weakening structures, for example scratch lines, can also be attached from the outside.

One or more labeling fields 1010a may also be provided on the outside of the housing bottom 101a, which can be used for affixing various written information.

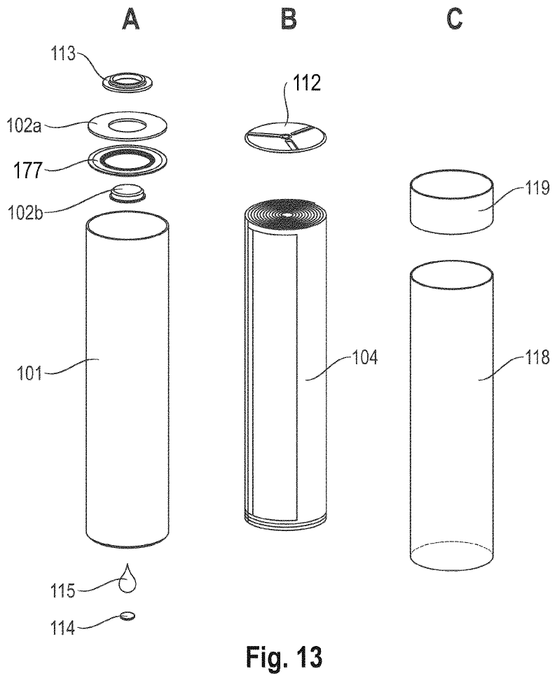

FIG. 13A-C shows exploded views of the various components of a preferred embodiment of an energy storage cell. FIG. 13A shows the components of the housing with the housing cup 101, the connection pole 102b, the O-ring-shaped insulating disc 177, the lid plate 102 with the central recess into which the connection pole 102b engages, and the casting compound 113. Below the housing cup 101, the closure for the energy storage cell is shown in the form of the metallic membrane 114, which closure is attached after the assembled cell has been filled with the electrolyte 115 schematically indicated here.

FIG. 13B shows the wound electrode-separator assembly 104 and the contact metal sheet 112 to be attached thereto. The assembly 104 can be produced in a manner known per se by winding the electrode tapes and the separators, in particular on a winding machine. To complete the winding shape, the outermost winding turn can preferably be bent inward by, for example, 30° to 45° using a conical pressure piece, so that the winding shape is stabilized. An adhesive tape 118 (FIG. 13C), for example made of polypropylene, is then preferably applied to the outer peripheral surface of the winding, which, in addition to its stabilizing function, also performs an electrically insulating function in the cell if necessary. After this stabilization of the wound assembly 104, the disc-shaped contact metal sheet 112, which is made of aluminum, for example, can be loosely placed on the upper end face of the winding and fixed with a particularly stable adhesive tape 119 made of polyimide, for example. For this purpose, a tape made of Kapton® with a thickness of 50 μm can be used, for example.

The assembly 104 with the attached contact metal sheet 112 can then be inserted into the cup-shaped housing part 101. After aligning the beads in the housing bottom and in the contact metal sheet, if necessary with the aid of a camera, the arrangement can be pressed together using suitable pressing tools and laser-welded from above and below to contact the longitudinal edges of the electrode strips with the respective beads, either simultaneously or sequentially. The connection pole 102b can then be placed on the contact metal sheet 112 and welded on.

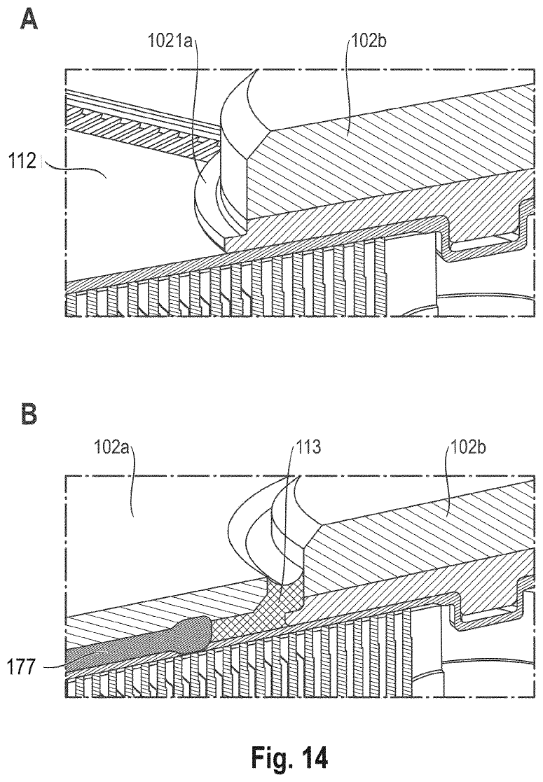

FIG. 14A, B show details of the production of the lid assembly of the cell. FIG. 14A shows a detailed view of the welding of the connecting pole 102b onto the contact metal sheet 112, whereby the laser can act at an angle or vertically, in particular in the region of the circumferential welding shoulder 1021a of the connecting pole 102b. FIG. 14B shows how the insulating disc 177 can then be inserted and pressed to the correct height before the lid plate 102a is placed on top and welded at an angle, vertically or horizontally to the cup-shaped housing part. Now the connection pole 102b can be pressed to the correct height in relation to the cell shoulder formed by the upper side of the lid plate 102a, if necessary. The distance provided for this purpose can be, for example, 1 mm between the top side of the connection pole 102b and the top side of the lid plate 102a. The gap between the lid plate 102a and the connection pole 102b is filled with a casting compound 113 in order to seal this part of the energy storage cell so that it is airtight and liquid-tight.

The energy storage cell can then be transferred to an oven to cure the casting compound 113 and bake out the residual moisture from the wound assembly.

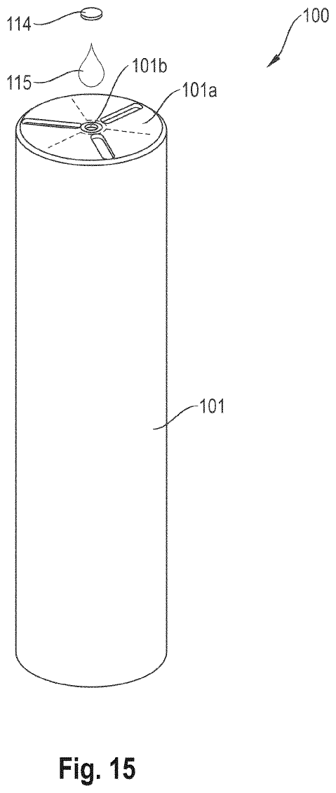

FIG. 15 illustrates the final filling with electrolyte 115, which is filled in from the bottom side of the energy storage cell 100 (at the top in this illustration) through the aperture 101b in the housing bottom 101a. Finally, the metallic membrane 114 is applied as a closure to the opening in the housing bottom 101a or as a closure to the central aperture 155. For this purpose, a vertical laser beam can be used, for example.

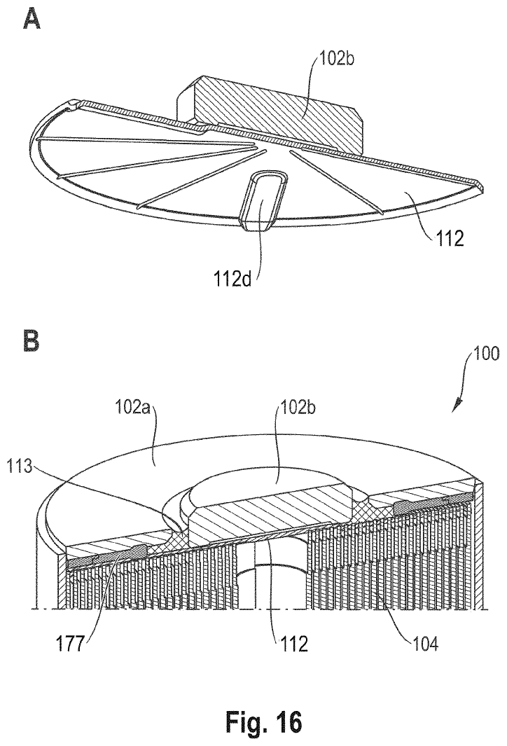

FIG. 16 illustrates an alternative option for mounting the lid assembly. FIG. 16A shows the contact metal sheet 112 with the connection pole 102b attached to it in a sectional view from below at an angle. FIG. 16B shows the upper end face area of the cell in a longitudinal section.

In this alternative manufacturing process, the connection pole 102b is welded to the contact metal sheet 112 in advance. Friction welding or friction stir welding can be used for this purpose.

In the design of the contact metal sheet 112 in this embodiment, the star-shaped beads 112d of the contact metal sheet 112 can be shortened if necessary, since they are covered by the connecting pole 102b during the subsequent welding of the electrode-separator assembly. Overall, therefore, slightly less welding surface is available for contacting the longitudinal edge of the respective electrode strip with the contact metal sheet 112. However, this design can offer advantages for assembly.

Since it may be easier to attach the connecting pole 102b directly to the contact metal sheet 112 outside the housing cup assembly, it is possible to dispense with a central depression in the contact metal sheet and a corresponding pin on the connecting pole 102b.

The further assembly of the energy storage cell with the connection pole 102b, which is already welded directly onto the contact metal sheet 112, does not differ in principle from the manufacturing method for the energy storage cell 100 described above.

FIG. 17 shows an example of a lid assembly 202 which can be installed as a lid in an energy storage element as shown in FIG. 1 or FIG. 2 or FIG. 3.

This comprises the metal disc 213 with the metallic membrane 214, which bulges outwards or bursts when there is excess pressure inside the housing. The metal disc 213 with the membrane 214 is in electrical and direct contact with the metallic pole cap 217, which seals the lid assembly 202 to the outside. It is also in electrical contact with an inner metal contact disc 215, but only via the metal membrane 214. Otherwise, the metal disc 213 and the contact disc 215 are electrically insulated from each other by the annular insulator 216. If the membrane 214 bulges outward as a result of excess pressure that can act directly on the membrane via the aperture 215a, the electrical contact between the metal disc 213 and the contact disc 215 is broken. At high pressures, the membrane may also burst. The conductors 113 of the cells shown in FIGS. 1 to 3 can be welded to the contact disc 213.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A secondary energy storage element, comprising:
a cathode and an anode as parts of an assembly; the cathode and anode being separated by a separator or solid electrolyte layer in a sequence cathode/separator or solid electrolyte layer/anode; and
a first contact metal sheet and/or a second contact metal sheet,
wherein the cathode comprises a cathode current collector and a positive electrode material,
wherein the anode comprises an anode current collector and a negative electrode material,
wherein:
the cathode current collector comprises a main region loaded on both sides with a layer of the positive electrode material, and a free edge strip that extends along an edge of the cathode current collector and is not loaded with the positive electrode material, and/or
the anode current collector comprises a main region loaded on both sides with a layer of the negative electrode material, and a free edge strip that extends along an edge of the anode current collector and is not loaded with the negative electrode material,
wherein the cathode and the anode are formed and/or arranged relative to one another within the assembly such that the free edge strip of the cathode current collector protrudes from one side of the assembly and/or the free edge strip of the anode current collector protrudes from another side of the assembly, and
wherein the first contact metal sheet is in direct contact with one of the free edge strips and/or the second contact metal sheet is in direct contact with the other of the free edge strips,
wherein the electrodes comprise at least one ion type from the group comprising sodium ions, potassium ions, calcium ions, magnesium ions, and aluminum ions, which are exchanged between the cathode and the anode during charging and discharging of the secondary energy storage element.

2. The energy storage element according to claim 1, wherein:
the cathode and anode, the cathode and anode current collectors, and the layers made of the electrode materials are ribbon-shaped,
the separator or the at least one ribbon-shaped solid electrolyte layer are ribbon-shaped,
the assembly is in the form of a winding in which the electrodes and the at least one separator are wound around a winding axis, the assembly comprises a first and a second terminal end face and a winding shell, and the free edge strip of the cathode current collector protrudes from the first end face and/or the free edge strip of the anode current collector protrudes from the second end face,
the energy storage element further comprises a housing comprising a housing shell or side walls and, at the end faces, a bottom and a lid, and
in the housing, the assembly formed as a winding is aligned in such a way that the winding shell rests against the inner side of the housing shell or the side walls.

3. The energy storage element according to claim 1, wherein:
the assembly is in the form of a prismatic stack in which the cathode and the anode are stacked together with further cathodes and anodes,
the electrodes and the current collectors as well as the layers made of the electrode materials are polygonal,
the energy storage element further comprises at least one ribbon-shaped or polygonal separator or at least one ribbon-shaped or polygonal solid electrolyte,
the stack is enclosed by a prismatic housing.

4. The energy storage element according to claim 1, wherein at least one of:
the energy storage element is a sodium-ion cell.
the energy storage element comprises a sodium-ion cell.
the energy storage element comprises one of the following electrolytes:
NaClO₄ dissolved in at least one organic solvent, in particular in PC or in a carbonate mixture from the group comprising EC/DEC/FEC and PC/FEC;
NaPF₆ and/or NaTFSI dissolved in at least one organic solvent, in particular in PC or in a carbonate mixture from the group comprising EC/DEC/FEC, EC/PC, EC/DEC, FEC/EMC and PC/FEC or in an ether mixture such as THF/mTHF;
NaFSI and/or NaTFSI and/or NaTDI dissolved in at least one organic solvent, in particular in 1,4-dioxane (DX) and/or 1,3-dioxolane (DOL) and/or dimethyl ether (DME);
NaFSI and/or NaTFSI and/or NaTDI dissolved in at least one organic solvent, in particular in dimethyl carbonate and/or tris(2,2,2-trifluoroethyl) phosphate (TFP);
NaN(SO₂F)₂ dissolved in at least one organic solvent, in particular in 1,4-dioxane and/or 1,3-dioxolane (DOL) and/or dimethyl ether (DME);
NaBF₄ dissolved in at least one organic solvent, in particular in tetraethylene glycol dimethyl ether (TEGDME) and/or in ACN and/or in PC and/or GBL.

5. The energy storage element according to claim 1, wherein at least one of:
the anode comprises a matrix with depressions and/or pores in which metallic sodium is stored;
the matrix adheres to the surface of the anode current collector;
the matrix comprises carbon particles and a binder;
the matrix comprises conductive agents and/or fillers;
the matrix is a roughened surface of the anode current collector.

6. The energy storage element according to claim 1, wherein:
the anode comprises a nucleation layer in which metallic sodium is stored and/or on which metallic sodium is deposited;
the nucleation layer comprises at least one material from the group comprising tin, silver, gold, germanium, carbon, platinum, zinc, aluminum, magnesium, and silicon;
the nucleation layer is deposited on the surface of the anode current collector via PVD (physical vapor deposition) or CVD (chemical vapor deposition).

7. The energy storage element according to claim 6, wherein at least one of the following additional features:
the negative electrode comprises the layer sequence metallic current collector/matrix or nucleation layer and cover layer;
the nucleation layer is thus arranged between the cover layer and the current collector;
the cover layer has a thickness in a range from 300 nm to 30 μm;
the cover layer is formed from a ceramic material or comprises such a ceramic material;
the cover layer comprises aluminum oxide (Al₂O₃), aluminum hydroxide or aluminum oxide hydroxide (AlOOH), silicon oxide (SiOₓ with x in a range from >1 and ≤2), titanium oxide (TiO₂), titanium nitride (TiN), titanium aluminum nitride (TiAlN) or titanium carbonitride (TiCN).

8. The energy storage element according to claim 2, wherein at least one of:
the energy storage element comprises an airtight and liquid-tight housing having a metallic, cup-shaped housing part with the bottom and a terminal circular opening, and a lid with a circular edge which closes the terminal circular opening;
the assembly is arranged in axial alignment in the cup-shaped housing part, the first end face pointing in the direction of the lid and the second end face pointing towards the bottom;
the energy storage element comprises an annular seal made of an electrically insulating material that surrounds the circular edge of the lid and electrically insulates the cup-shaped housing part and the lid from each other;
the cup-shaped housing part comprises an inner side and an outer side and, in axial succession, the bottom, a central section and a closure section, wherein
the central section is cylindrical and, in the central section, the winding shell of the assembly formed as a winding is in contact with the inner side of the cup-shaped housing part, and
in the closure section, the annular seal is in press contact with the lid and the inner side of the cup-shaped housing part;
the central section and the closure section are separated by an indentation which circumferentially surrounds the outer side of the cup-shaped housing part;
the contact metal sheet is connected electrically to the free edge strip of the current collector protruding from the first terminal end face by welding and to the lid;
the energy storage element comprises at least one insulating element made of an electrically insulating material, which insulates the contact metal sheet and/or the free edge strip of the current collector protruding from the end face and/or a separate electrical conductor fixed to the contact metal sheet from direct contact with the inner side of the cup-shaped housing part.

9. The energy storage element according to claim 1, wherein at least one of:
the energy storage element comprises an airtight and liquid-tight housing which has a metallic, cup-shaped housing part with a bottom and a terminal opening, and a lid which closes the terminal opening;
the lid comprises a metallic lid plate and a connection pole which is guided through an aperture in the lid plate and which is electrically insulated from the lid plate;
the assembly is arranged in the cup-shaped housing part, with one side facing the lid and with a second side facing the bottom, and optionally being in direct contact with the bottom;
the cathode and the anode are formed and/or arranged within the assembly in such a way that the free edge strip of the cathode current collector protrudes from the side of the assembly and the free edge strip of the anode current collector protrudes from one side of the assembly;
the contact metal sheet rests directly on the free edge strip of one of the current collectors protruding from one of the sides of the assembly and is connected to it by welding;
the contact metal sheet is either electrically connected to the connecting pole passing through the aperture in the lid plate, preferably directly welded to the connecting pole, or the connecting pole is part of the contact metal sheet;
the connection pole is electrically insulated from the lid plate by a hardened casting compound made of an electrically insulating plastic material.

10. The energy storage element according to claim 9, wherein:
the edge strip of the cathode current collector or of the anode current collector not being in direct contact with the contact metal sheet is electrically connected to the housing bottom by being welded directly to the housing bottom.

11. The energy storage element according to claim 9, wherein:
between the lid plate and the contact metal sheet there is an annular gap filled with the casting compound;
the annular gap is bounded radially outwardly by an O-ring-shaped insulating disc made of an electrically insulating plastic material.

12. The energy storage element according to claim 9, wherein:
the housing bottom of the cup-shaped housing part has a primary safety device against internal overpressure in the form of an aperture closed via a metallic membrane;
the housing bottom of the cup-shaped housing part has a secondary safety device against internal overpressure in the form of at least one groove on its inner side or its outer side.

13. A battery comprising at least two energy storage elements according to claim 1 connected in parallel and/or in series.

14. The battery according to claim 13, wherein the battery has a nominal voltage of 12V or 24V.
